(19) United States
(12) Patent Application Publication
(10) Pub. No.: US 2021/0090169 A1
(43) Pub. Date: Mar. 25, 2021

(54) PLATFORM FOR ACTIVE NON-TRANSPARENT EXCHANGE-TRADED FUNDS

(71) Applicant: Invesco Holding Company (US), Inc., Atlanta, GA (US)

(72) Inventors: Lorraine Wang, Scarsdale, NY (US); Anna Paglia, Wheaton, IL (US); Jason Richard Stoneberg, Wheaton, IL (US); Bradley Hepburn Smith, Wheaton, IL (US); Eric Mark Pollackov, Morganville, NJ (US); William Seng Geyer, Santa Barbara, CA (US)

(21) Appl. No.: 17/029,531

(22) Filed: Sep. 23, 2020

Related U.S. Application Data
(60) Provisional application No. 62/904,254, filed on Sep. 23, 2019.
(60) Provisional application No. 62/983,163, filed on Feb. 28, 2020.
(60) Provisional application No. 63/040,223, filed on Jun. 17, 2020.

(51) Int. Cl. G06Q 40/04; H04L 29/06; G06Q 40/06

(52) U.S. Cl. CPC G06Q 40/04; G06Q 40/06; H04L 63/102

(57) ABSTRACT

The techniques disclosed herein permit active, non-transparent management of financial assets within an exchange-traded fund while yielding the traditional advantages of scale and cost efficiency for secondary market participants. The fund may supplement traditional periodic disclosures of holdings with additional information to facilitate accurate intraday pricing of ETF shares. In this context, a substitute basket may be engineered and published on a daily basis that closely tracks the fund composition, but contains an active share of about 5-30% relative to the fund in order to obfuscate the actual fund holdings. This substitute basket may advantageously provide a high quality signal of fund value, while also facilitating in-kind transactions in the primary market that are closely related to the fund composition without revealing specific fund holdings or weightings.

### CROSS-REFERENCE TO RELATED APPLICATIONS

This application claims priority to U.S. Provisional Patent Application No. 62/904,254 filed on Sep. 23, 2019, U.S. Provisional Patent Application No. 62/983,163 filed on Feb. 28, 2020, and U.S. Provisional Patent Application No. 63/040,223 filed on Jun. 17, 2020. The contents of each of the foregoing is hereby incorporated by reference in its entirety.

### TECHNICAL FIELD

This disclosure relates to exchange-traded funds, and more particularly to creating, redeeming, and trading in an active, non-transparent exchange-traded fund.

### BACKGROUND

Exchange-traded funds (ETFs) provide individual investors with cost-effective access to large baskets of securities. In an ETF, a fund that owns a portfolio of financial instruments issues shares in the portfolio for trading in a secondary market such as a stock exchange where individual investors can buy and sell the shares in trades of any suitable size. Investment companies that operate ETFs do not sell these shares directly to the general public. Instead, ETFs distribute and redeem shares through authorized participants (APs), typically in “creation units” of 10,000-50,000 shares or multiples thereof. The APs, in turn, serve as a bridge to secondary markets used by other traders. Shares in an ETF generally trade in the secondary markets at a price based on the net asset value (NAV) of the underlying portfolio held by the ETF.

Early ETFs were passive vehicles that tracked published indices such as the S&P 500. These so-called index funds enable investors to obtain exposure to the securities of an entire market or index with a single tradeable product, and they still constitute the majority of ETFs that are traded today. In recent years, however, actively managed ETFs have emerged as an alternative to passive funds. In an actively managed ETF, a portfolio manager can make discretionary trades in an effort to increase returns. Historically, these active ETFs have been required to disclose their holdings on a daily basis so that investors can properly value the underlying ETF shares, and so that APs can conduct creation or redemption transactions with the ETF via in-kind exchanges in which ETF shares are exchanged for a basket of the underlying financial assets held by the ETF.

While these disclosure requirements appear to work adequately, they can also impose limits on an active manager's ability to trade effectively for the benefit of the ETF. For example, the daily disclosure of an active ETF's holdings can reveal the investment strategy of the manager of the active ETF, thereby allowing duplication of a fund strategy by others. This also creates the possibility of front-running the fund's individual trades, where third parties seek to benefit by anticipating a fund manager's future trades. There remains a need for an improved ETF structure that permits a portfolio manager to make discretionary trades without disclosure, while still providing sufficient pricing information for market makers and other traders to accurately estimate the value of ETF shares.

### SUMMARY

The techniques disclosed herein permit active, non-transparent management of financial assets within an exchange-traded fund while yielding the traditional advantages of scale and cost efficiency for secondary market participants. The fund may supplement traditional periodic disclosures of holdings with additional information to facilitate accurate intraday pricing of ETF shares. In this context, a substitute basket may be engineered and published on a daily basis that closely tracks the fund composition, but contains an active share of about 5-30% relative to the fund in order to obfuscate the actual fund holdings. This substitute basket may advantageously provide a high quality signal of fund value, while also facilitating in-kind transactions in the primary market that are closely related to the fund composition without revealing specific fund holdings or weightings.

In one aspect, Authorized Participants (“APs”) can transact directly in the substitute basket, which facilitates efficient arbitrage and hedging with resultant narrower bid/ask spreads that can encourage participation in the primary and secondary markets for the fund's shares. At the same time, pricing information such as a periodic indicative net asset value, intraday net asset value, and daily disclosure of metrics such as composition of the substitute basket, active share, tracking error, asset allocation, and the like may be published. This provides useful information for secondary market trading, while also offering sufficient price information to encourage the creation and redemption of ETF shares by APs in response to excess supply or demand. In another aspect, an affiliated broker-dealer may be positioned between the fund and APs for certain transactions so that an AP is not exposed to the fund composition when using the substitute basket to create or redeem ETF shares.

The substitute basket can be configured to closely track the creation basket used by the fund to create or redeem. For example, the substitute basket may have an overlap (e.g., 80%, 85%, 90%, 95%, or some other value) with the securities held by the fund, or stated differently, may have an active share of about 5-30% relative to the benchmark fund. The active share may include overweighting or underweighting of securities, or the inclusion or exclusion of certain securities in a manner that varies holdings relative to the fund. By disclosing only the substitute basket, the systems, devices, and methods described herein can discourage front-running of fund trades. For example, the substitute basket may also exclude, underweight, or overweight securities in the ETF that are about to be traded in the near future, thereby reducing the risk of free-riding or front-running with respect to those specific trades.

Additionally, systems, devices, and methods disclosed herein may reduce price discrepancies between ETF net asset value (NAV) and the secondary market price of ETF shares by allowing more price-related information to be published more frequently. In some implementations, an actual or estimated value of the fund holdings, or some other indicative net asset value, may be published frequently (e.g., every 1 second, 2 seconds, 5 seconds, 10 seconds, 15 seconds, 1 minute, 2 minutes, 5 minutes, 10 minutes, 15 minutes, etc.) to allow frequent estimations of the value of the ETF. Other metrics related to the substitute basket may be published along with the substitute basket composition, such as the active share of the substitute basket relative to the fund holdings that formed the basis for the last NAV calculation, a daily deviation between the performance of the substitute basket and the ETF, or any other quantitative measure or combination of measures. These substitute basket metrics can facilitate independent calculations or estimates of real time value by market participants for purposes of trading, hedging, and arbitrage.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 is a block diagram of a computerized system for transacting in exchange-traded funds.

FIG. 2 is a diagram of a computing device for use in the methods and systems described herein.

FIG. 3A illustrates a method for creation of a substitute basket.

FIG. 3B illustrates a user interface for creation of a substitute basket.

FIG. 4 illustrates a system for publishing valuation information.

FIG. 5 illustrates a method for creating exchange-traded fund shares using a substitute basket.

FIG. 6 illustrates a method for redeeming exchange-traded fund shares using a substitute basket.

FIG. 7 illustrates a method for creating exchange-traded fund shares using cash.

FIG. 8 illustrates a method for redeeming exchange-traded fund shares using cash.

FIG. 9 illustrates a method for creating exchange-traded fund shares using a custom basket of securities.

FIG. 10 illustrates a method for redeeming exchange-traded fund shares using a custom basket of securities.

FIG. 11 is a block diagram of a computerized system including an intermediary for transacting in exchange-traded funds.

FIG. 12 shows a system for managing a fund with multiple share classes.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better describe the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

To provide an overall understanding of the disclosure, certain illustrative implementations will now be described, including systems, methods, and devices for creating, redeeming, and publishing price information for shares of exchange-traded funds, as well as the creation and use of substitute baskets in any of the foregoing. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. Generally, the computerized systems described herein may comprise one or more engines, platforms, modules, compute instances, or the like, which may include a processing device or devices, such as a computer, microprocessor, logic device, or other device or processor that is configured with hardware, firmware, and/or software to carry out one or more of the computerized methods described herein.

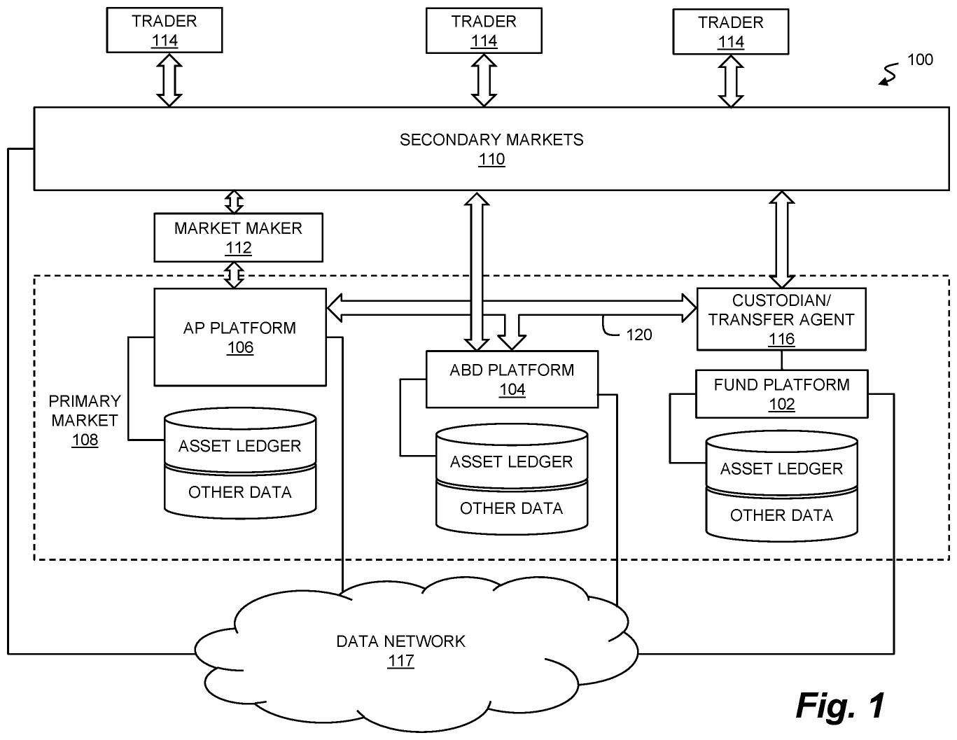

FIG. 1 is a block diagram of a computerized system for transacting in exchange-traded funds. In general, the system 100 may include a fund platform 102, an affiliated broker-dealer platform (“ABD platform”) 104, and an authorized participant platform (“AP platform”) 106 coupled in a communicating relationship to form a primary market 108 for ETF shares. In general, the AP platform 106 may interact with secondary markets 110 through a market maker 112 or other liquidity provider or the like, and traders 114 may transact among one another (and with the market maker 112) in ETF shares and other securities in the secondary markets 110.

The fund platform 102 may be a computing device or computer system operated by an investment company that sponsors an exchange-traded fund. The fund may be formed of any suitable financial instruments including, without limitation, assets such as U.S. securities, foreign securities, other exchange-traded funds or mutual funds, corporate or government bonds, depositary receipts, unit trusts, and/or any other financial assets or instruments suitable for inclusion in an exchange-traded fund. The fund platform 102 may store data such as an asset ledger and other data associated with tracking the fund's composition and supporting fund disclosures such as those described herein. The fund platform 102 may communicate with a custodian 116 (or transfer agent, or combination of these, referred to herein for simplicity as the “custodian 116”) responsible for holding and transacting in fund assets in a custodial capacity. Thus, while an investment company that operates the fund platform 102 may control the composition of a fund, trade executions on behalf of the investment company may be performed through the custodian 116. This may include transactions in the primary market 108, such as ETF share creations and redemptions, as well as transactions in the secondary markets 110, e.g., to adjust holdings of the fund under the direction of a portfolio manager. The fund platform 102 may also be coupled in a communicating relationship with a data network 117, which may be used, e.g., to publish fund information, substitute basket information, pricing and valuation metrics for the fund, and so forth.

In one aspect, some or all of the data in the asset ledger and other data stored by the fund platform 102, such as transaction histories, share types and allocations, fund holdings, ownership information, and so forth may be maintained using a block chain or other distributed ledger or the like in order to facilitate improved transparency, transaction authentication, and so forth. Similarly, the other platforms (such as the ABD platform 104 and the AP platform 106) may also or instead use distributed ledgers to log transaction histories, share data, authenticate transactions, and so forth. While distributed ledgers are well known and supported by a variety of consensus-based technologies, other centralized technologies may also or instead be used to store and maintain data while similarly supporting transparency, authentication, and so forth.

The ABD platform 104 may participate in ETF creation and redemption processes at the instruction of the authorized participant, as more generally described herein. The ABD platform 104 may store an asset ledger of assets owned or controlled by the affiliated broker-dealer (such as assets controlled on behalf of the AP), along with other data useful for transacting in financial assets and ETF shares as described herein. In one aspect, the ABD platform 104 may usefully separate the AP platform 106 from the fund platform 102 so that the fund platform 102 can transact in a fund basket while the AP platform transacts in a substitute basket. In such transactions, the ABD platform 104 may convert holdings between these two baskets in a manner that permits in-kind transactions by the AP platform 106 using the substitute basket while shielding the fund platform 102 from disclosing the composition of the fund, e.g., through disclosure of the fund's creation basket. In general, the ABD platform 104 may be coupled in a communicating relationship with the AP platform 106 and the fund platform 102 (via the custodian 116) in order to participate in primary market 108 transactions for ETF shares. The ABD platform 104 may also be coupled to the secondary markets 110 in order to transact in securities and other assets as necessary to convert between the creation basket and the substitute basket. The ABD platform 104 may also be coupled in a communicating relationship with the data network 117 in order to support communications with other market participants, retrieve market data, publish ABD platform 104 information, and so forth.

In general, the terms “creation basket” and “fund basket” are used herein to refer to a basket of securities that the fund is willing to accept or deliver against a subscription or redemption request of ETF shares. Such a creation basket or fund basket may include, or be accompanied by a cash balance as needed to adjust the value of the basket in order to match the value of a corresponding creation unit without the use of fractional shares or the like.

The AP platform 106 may generally facilitate the creation and redemption of ETF shares to increase or decrease ETF shares in the secondary markets 110. In general, the AP platform 106 may monitor a price of ETF shares in the secondary markets 110, and where the ETF shares appear to trade at a discount or premium to a (per share) net asset value, may responsively add ETF shares through an ETF creation process or remove ETF shares through a redemption process. In general, An AP can purchase or redeem creation units from a fund either as a principal for the AP's own account or as an agent for others, such as market makers, proprietary trading firms, hedge funds, or other institutional investors. An AP may also keep some ETF inventory on the books for liquidity or for hedging purposes.

In one aspect, ETF shares may be created or redeemed in the system 100 without concurrently revealing the complete fund composition to the secondary markets 110. For example, the AP platform 106 may initiate creation or redemption of creation units of ETF shares using a substitute basket of securities rather than a fund basket, and may transact through the ABD platform 104 in order to prevent disclosure of the fund composition to the AP platform 106 during such transactions. In order to accomplish this, the fund platform 102 may disclose the fund basket composition to the ABD platform 104 (e.g., so that the ABD platform 104 can accurately translate between the fund basket and the substitute basket), but does not disclose the fund basket composition to the AP platform 106.

Because the fund composition is not publicly disclosed, the fund platform 102 may provide other valuation or pricing information to assist markets in assessing the value of ETF shares. For example, in order to reduce price discrepancies between ETF NAV and the secondary market price of ETF shares, the fund platform 102 may frequently publish an indicator of share value such as an estimate based on the fund holdings, an indicative net asset value, or a value of the substitute basket (e.g., once every 1 second, 2 seconds, 5 seconds, 10 seconds, 15 seconds, 1 minute, 2 minutes, 5 minutes, 10 minutes, 15 minutes, etc.) along with some combination of other valuation metrics, such as the percentage weight overlap between the substitute basket (e.g., for the current day or the prior day) and the holdings of the ETF that formed the basis for the last NAV calculation (e.g., the last daily NAV), daily deviation between the performance of the substitute basket and the ETF, any other quantitative measures designed to facilitate an effective arbitrage mechanism, and/or any suitable combination of the foregoing. These substitute basket metrics allow market participants to independently calculate a real-time value of the substitute basket or otherwise estimate a net asset value for ETF shares, thereby facilitating arbitrage, hedging, and secondary market transactions.

Each platform in the primary market 108 may include a trade execution engine (not shown) for executing transactions in the primary market 108, and may be operatively coupled to other primary market participants for initiating and confirming transactions in the primary market 108, as illustrated by an arrow 120. The participants may also generally be coupled, either directly or through a market maker 112, to the secondary markets where shares in various financial assets can be purchased and sold as necessary to adjust holdings of the fund, convert between a fund basket and the substitute basket, or otherwise engage in transactions consistent with the methods and systems described herein. The market maker 112 may also more generally provide liquidity in the secondary market 110 for ETF shares and the other underlying securities and other assets described herein.

In general, the traders 114 may include individual investors (acting through brokers), institutional investors, or any other investors who might buy and sell ETF shares on the secondary markets 110. The traders 114 may also include brokers who wish to buy or sell retail quantities of ETF shares for their own account. Large institutional investors may buy or sell ETF shares on the secondary markets 110, or through alternative trading venues such as Over-the-Counter and Dark Pools (not shown).

The custodian 116 (and/or transfer agent) generally facilitates activities of the fund platform 102 in a custodial capacity. For example, the fund platform 102 may communicate market trades to the custodian 116, as well as details of the creation basket, creation and redemption requests, and so forth. The custodian 116 in turn provides safekeeping of fund assets, and may provide aggregate fund information, settlement information, and so forth to the investment company operating the fund platform 102. The custodian 116 may also work with the fund platform 102 to process and settle creations and redemptions when orders are received from the AP platform 106. The custodian 116 may also provide other supporting functions, such as nightly communication of creation/redemption baskets to the National Securities Clearing Corporation (or the Depository Trust Company or similar entity), which in turn may communicate this information to the secondary markets 110.

As used herein, the term “platform” may refer to one or more computers, microprocessors, logic devices, servers, or other devices configured with hardware, firmware, and software to carry out one or more of the computerized techniques described herein. Processors and processing devices may also include one or more memory devices for storing inputs, outputs, and data that are currently being processed. It will be understood that FIG. 1 is illustrative only, and that any number of traders 114, market makers 112, AP platforms 106, and so forth may participate in the system 100 without departing from the scope of this disclosure.

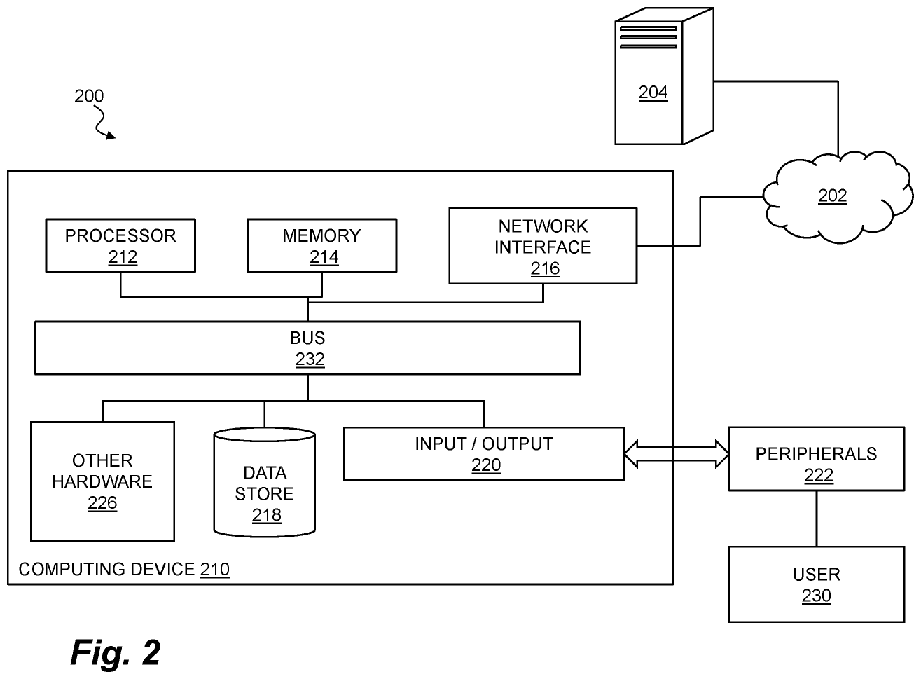

FIG. 2 is a diagram of a computer system 200 for use in the methods and systems described herein. In general, the device 200 of FIG. 2 may be used to implement the fund platform 102, the ABD platform 104, the AP platform 106 as described above and herein, or any of the other platforms or entities described herein, and may also or instead be used to perform various steps of the methods described herein, e.g., when programmed by computer executable code stored in memory and executable by a processor.

The computer system 200 may include a computing device 210 connected to a network 202, e.g., through an external device 204. The computing device 210 may be or include any type of network endpoint or endpoints as described herein. For example, the computing device 210 may include a desktop computer workstation. The computing device 210 may also or instead be any other device that has a processor and communicates over a network 202, including without limitation a laptop computer, a desktop computer, a personal digital assistant, a tablet, a mobile phone, a television, a set top box, a wearable computer, and so forth. The computing device 210 may also or instead include a server, or it may be disposed on a server or within a virtual or physical server farm. In certain aspects, the computing device 210 may be implemented using hardware (e.g., in a desktop computer), software (e.g., in a virtual machine or the like), or a combination of software and hardware (e.g., with programs executing on the desktop computer), and the computing device 210 may be a standalone device, a device integrated into another entity or device, a platform distributed across multiple entities, or a virtualized device executing in a virtualization environment.

The network 202 may include any network or combination of networks, such as one or more data networks or internetworks suitable for communicating data and control information among participants in the computer system 200. The network 202 may include public networks such as the Internet, private networks, and telecommunications networks such as the Public Switched Telephone Network or cellular networks using third generation cellular technology (e.g., 3G or IMT-2000), fourth/fifth generation cellular technology (e.g., 4G, LTE, MT-Advanced, E-UTRA, 5G, etc.) or WiMax-Advanced (IEEE 802.16m)) and/or other technologies, as well as any of a variety of corporate area, metropolitan area, campus, or other local area networks or enterprise networks, along with any switches, routers, hubs, gateways, and the like that might be used to carry data among participants in the computer system 200. The network 202 may also include a combination of data networks, and need not be limited to a strictly public or private network.

The external device 204 may be any computer or other remote resource that connects to the computing device 210 through the network 202. This may include threat management resources such as any of those contemplated above, gateways or other network devices, remote servers or the like containing content requested by the computing device 210, a network storage device or resource, a device hosting content, or any other resource or device that might connect to the computing device 210 through the network 202.

The computing device 210 may include a processor 212, a memory 214, a network interface 216, a data store 218, and one or more input/output devices 220. The computing device 210 may further include or be in communication with one or more peripherals 222 and other external input/output devices 224.

The processor 212 may be any as described herein, and in general may be capable of processing instructions for execution within the computing device 210 or computer system 200. In one aspect, the processor 212 may be capable of processing instructions stored in the memory 214 or on the data store 218.

The memory 214 may store information within the computing device 210 or computer system 200. The memory 214 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 214 may store program instructions, program data, executables, and other software and data useful for controlling operation of the computing device 210 and configuring the computing device 210 to perform functions for a user. While a single memory 214 is depicted, it will be understood that any number of memories may be usefully incorporated into the computing device 210. For example, a first memory may provide non-volatile storage such as a disk drive for permanent or long-term storage of files and code even when the computing device 210 is powered down, and a second memory such as a random-access memory may provide volatile (but higher speed) memory for storing instructions and data for executing processes.

The network interface 216 may include any hardware and/or software for connecting the computing device 210 in a communicating relationship with other resources through the network 202. This may include connections to resources such as remote resources accessible through the Internet, as well as local resources available using short range communications protocols using, e.g., physical connections (e.g., Ethernet), radio frequency communications (e.g., WiFi or Bluetooth), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any other data reading or writing resource or the like. More generally, the network interface 216 may include any combination of hardware and software suitable for coupling the components of the computing device 210 to other platforms, computing or communications resources, and so forth.

The data store 218 may be any internal memory store providing a computer-readable medium such as a disk drive, an optical drive, a magnetic drive, a flash drive, memory card, or other device capable of providing mass storage for the computing device 210. The data store 218 may store computer readable instructions, data structures, program modules, and other data for the computing device 210 or computer system 200 in a non-volatile form for subsequent retrieval and use. The data store 218 may store computer executable code for an operating system, application programs, and other program modules, software objects, libraries, executables, and the like the like. The data store 218 may also store program data, databases, files, media, and so forth.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices.

The peripherals 222 may include any device or combination of devices used to provide information to or receive information from the computing device 210. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset or any other audiovisual device for presenting information to a user or otherwise providing machine-usable or human-usable output from the computing device 210. The peripheral 222 may also or instead include a digital signal processing device, an actuator, or other device to support control of or communication with other devices or components.

Other hardware 226 may be incorporated into the computing device 210 such as a co-processor, a digital signal processing system, a math co-processor, a graphics engine, a video driver, and so forth. The other hardware 226 may also or instead include expanded input/output ports, extra memory, additional drives (e.g., a DVD drive or other accessory), and so forth.

A bus 232 or combination of busses may serve as an electromechanical platform for interconnecting components of the computing device 210 such as the processor 212, memory 214, network interface 216, other hardware 226, data store 218, and input/output interface 220. As shown in the figure, each of the components of the computing device 210 may be interconnected using a system bus 232 or other communication mechanism for communicating information.

Methods and systems described herein can be realized using the processor 212 of the computer system 200 to execute one or more sequences of instructions contained in the memory 214 to perform predetermined tasks. In embodiments, the computing device 210 may be deployed as a number of parallel processors synchronized to execute code together for improved performance, or the computing device 210 may be realized in a virtualized environment where software on a hypervisor or other virtualization management facility emulates components of the computing device 210 as appropriate to reproduce some or all of the functions of a hardware instantiation of the computing device 210.

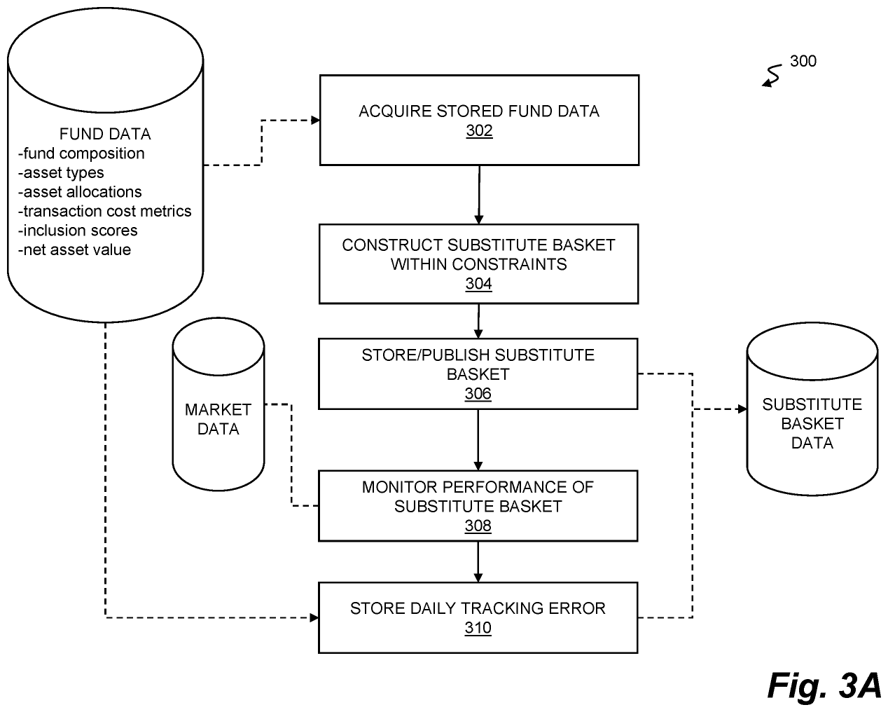

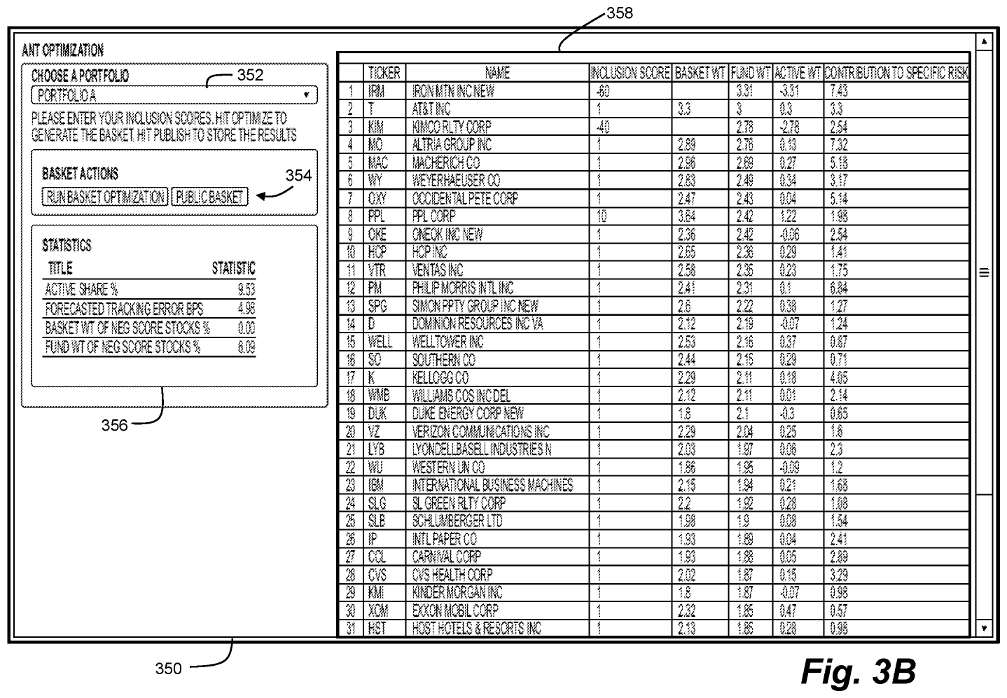

FIG. 3A illustrates a method for creation of a substitute basket. In general, the substitute basket may be advantageously engineered to serve a number of separate functions that collectively facilitate efficient trading in ETF shares concurrently with limited disclosure of fund holdings. In one aspect, the substitute basket is configured to have a value that closely tracks the net asset value of the fund, e.g., by optimizing to keep a forecasted daily tracking error (relative to the fund) below a predetermined threshold such as below five basis points. The substitute basket may also concurrently be configured to obfuscate fund holdings by maintaining an active share of the substitute basket (relative to the fund) above a predetermined threshold or within a predetermined range, such as 5-20% or 5-30%. The substitute basket is also configured to support in-kind transactions by APs using the substitute basket instead of a creation basket for the fund, which would otherwise reveal holdings of the fund. This function of the substitute basket is supported in part by the high correlation to the fund value, but can also usefully be augmented by optimizing for liquidity, e.g., by controlling the active share in a manner that minimizes transaction costs or otherwise encourages a substitute basket with sufficiently liquid for efficient trading. While optimizing for all of these parameters that support use of the substitute basket as described herein, the foregoing process may also provide some limited control to a portfolio manager over whether specific assets of the fund are included in, or excluded from, the substitute basket.

As shown in step 302, the method 300 may include acquiring stored fund data, such as data stored by the fund platform. For example, this may include the fund composition more specifically characterized by a selection and weighting of financial assets held by the fund, along with the net asset value (NAV) for a most recent NAV strike. In another aspect, this may include asset types and/or asset allocations for financial assets held by the fund. For example, this may include asset classes such as stocks, bonds, cash, real estate, commodities, financial derivatives, and so forth. This may also include sector allocations, currency allocations, geographic allocations, and any other types of allocations useful for estimating the expected performance and correlation of various financial assets. For example, in a fixed income context, performance or valuation metrics may include credit quality, duration, interest rate, maturity, and so forth.

One useful metric for a substitute basket is the transaction costs associated with trading assets in the substitute basket, or the liquidity of the substitute basket, which is generally (although not universally) inversely related to the transaction cost for trading in each of the financial assets in the substitute basket. That is, for a particular asset, the transaction costs will tend to decrease as liquidity increases. A metric for either liquidity or transaction costs may be used to evaluate the substitute basket, with a more liquid portfolio generally being more desirable due to lower transaction costs in trading of the underlying securities. Thus for example, acquiring stored fund data may include acquiring a transaction cost metric such as bid-ask spreads, volatility, median daily dollar volume or share volume, actual transaction costs associated with trades, commissions for trades, or any other direct or indirect measures of liquidity for various financial assets. Certain of these metrics are calculated over a period of time, and reflect variability in the underlying price or volume that may affect expected liquidity. It will be appreciated that some of these metrics are time-based, for which a longer window may tend to mute short term trends while a shorter window may provide too small a sample to capture price behavior. One of ordinary skill in the art will appreciate this trade off, and may make suitable selections to obtain metrics that serve as a useful proxy for transaction costs. For example, the dollar or share volume may be measured over a predetermined historical window such as five days, ten days, or twenty days, whereas the price volatility might typically be measured over a longer window such as a month or more.

According to the foregoing, it will be understood that the method 300 may also include storing the corresponding information, e.g., in a data store associated with the fund platform. Thus for example, the method 300 may include storing a composition of the fund, the composition including a selection and weight for a number of financial assets held by the fund. The method 300 may also or instead include storing a transaction cost metric for each of the number of financial assets. The method 300 may also include storing a number of asset types, each asset type having a number of categories exhaustively characterizing the financial assets held by the fund.

In one aspect, the fund data may include inclusion scores provided by a portfolio manager. Inclusion scores may provide a mechanism for a portfolio manager to control, within certain constraints, whether the selection and/or weighting of particular financial assets held by the fund are to be disclosed in a substitute basket. For example, a positive value for one of the inclusion scores may weight a corresponding one of the number of financial assets to favor inclusion in the substitute basket, a negative value for one of the inclusion scores may weight one of the number of financial assets to favor exclusion from the substitute basket, and a zero inclusion score may reduce the effect of the current weighting of an asset in the fund on inclusion of the asset in the substitute basket. Using these tools, negative inclusion scores may be applied by an optimization engine to discourage the inclusion of assets in the substitute basket, and positive inclusion scores may be applied by the optimization engine to encourage the inclusion of assets in the substitute basket. In one aspect, high positive inclusion scores may be used to encourage the inclusion of assets that are not currently in the fund holdings (e.g., with an actual, current weight of 0%). High negative inclusion scores may be used to encourage the exclusion of assets from the substitute basket (e.g., to obtain an adjusted weight of 0%). It will be understood that other ranges of inclusion values, or other weighting techniques or the like, may also or instead be used, provided they generally facilitate user control over biasing a particular asset toward inclusion in or exclusion from a substitute basket.

In one aspect, the portfolio may initially be weighted with an inclusion score of one for each financial asset, and the portfolio manager may be provided with a budget (e.g., of 50 points for inclusion, and −50 points for exclusion) to allocate as desired to encourage or discourage the inclusion of particular assets in the substitute basket. It will be understood that these inclusion and exclusion budgets are somewhat arbitrary, and may be scaled or allocated in any useful proportion according to the manner in which a particular optimization engine generates substitute basket holdings, and/or the degree to which a portfolio manager is permitted to control allocations. These inclusion scores (one for each financial asset) may be received from the portfolio manager, e.g., in a user interface for the fund platform, and used by an optimizer as described herein to select and weight assets in a substitute basket that is representative of, but not identical to, a composition of financial assets held by the fund.

As shown in step 304, the method 300 may include constructing the substitute basket within provided constraints. The constraints may include user-provided constraints, system provided constraints, or some combination of these. For example, the inclusion and exclusion scores may be provided, as well as an active share window, a forecasted daily tracking error threshold, asset correlations, minimum position sizes, and so forth.

In one aspect, constructing the substitute basket may include determining an adjusted weight for each financial asset in the substitute basket according to an objective function that maximizes a weighted average inclusion score and minimizes transaction costs for the substitute basket, while constraining the adjusted weights such that: (1) allocations in the substitute basket remain within a predetermined percentage for each of the number of categories for each asset type held by the fund, (2) the substitute basket has an active share within a predetermined range, (3) the adjusted weight is no less than one tenth of one percent for any non-zero adjusted weight, and (4) the substitute basket has a forecasted daily tracking error less than or equal to a predetermined threshold. The predetermined range for active share may vary according to asset types. For example, for funds composed of U.S. securities or the like, the active share window may be 5-20%, while for fixed income funds, an active share window of 5-30% may be appropriate. For a substitute basket using liquid securities, or highly liquid securities such as equities with high daily trading volumes, the forecasted daily tracking limit by be lower, such as within 1%. More generally, any window size for active share may be used consistent with the opposing criteria of shielding asset disclosures and providing correlated price performance.

By way of a more specific example, optimization constraints may include an active share between 5-20%, while the category allocations such as country, currency, and Global Industry Classification Standard sector are maintained within +/−3% of the underlying portfolio. The Global Industry Classification Standard is an industry taxonomy currently including 11 sectors, 24 industry groups, 69 industries, and 158 sub-industries used to categorize publicly traded companies by their principal business activity. It will be understood that other taxonomies such as the FTSE's Industry Classification Benchmark may also or instead be used to classify industries associated with financial assets. Other optimization constraints may also be provided to facilitate the creation of a useful substitute basket. For example, cash may preferably match the underlying portfolio to within 0.001%, or more closely where practical. Other instruments such as futures, options, derivatives, and the like may also or instead have specific matching thresholds, or may be valued as cash-in-lieu of securities for purposes of optimization (or transacting), particularly where the underlying asset is difficult or impossible to transfer in-kind. In another aspect, the minimum position size for any asset in the substitute basket may be a weight of 0.1% in order to provide asset positions in transactable sizes. It will be appreciated that this 0.1% minimum may vary according to the size of the creation unit or substitute basket. That is, as a substitute basket becomes smaller, it may be appropriate to increase the size of this minimum weight in order to avoid fractional shares or the like within the substitute basket. Similarly, for larger substitute baskets, a smaller minimum weight (e.g., 0.05% or less) may be appropriate.

In one aspect, one or more of the inclusion scores may be zero. As illustrated in the objective function below, this may have the effect of reducing the effect of a corresponding asset's weight in the fund on that assets weight within the substitute basket. This does not mean that the asset will necessarily be excluded from the substitute basket. An asset with a zero inclusion score may nonetheless be placed in the substitute basket, e.g., due to a relatively large liquidity score and/or a relatively small penalty score. A zero inclusion score may be used in other ways. For example, certain stocks (or other assets) that are not in the fund basket may be assigned a zero inclusion score. This will bias these stocks against inclusion in the substitute basket, and as a result will tend to favor substitute selections from within the fund. Among other advantages, the resulting substitute basket may have lower transaction costs during creates and redeems. In general, an asset such as a stock may have an inclusion score greater than zero to favor inclusion in the substitute basket, less than zero to favor exclusion from the substitute basket, and zero to reduce the effect of the asset weightings within the fund on scoring with the objective function [Eq. 1] that is used to create the substitute basket.

In another aspect, the forecasted tracking error may be capped daily or annually. For example, the forecasted daily tracking error may have a limit of five basis points, or some other amount suitable to the underlying securities and/or asset classes. While five basis points provides a useful threshold for U.S. equities (or some similar threshold such as ten basis points or fifteen basis points), other thresholds may be used for other asset types. For example, a limit of thirty basis points may be used for international equities or other assets with greater volatility. As another example, a forecasted yearly tracking error may have a limit of about eighty basis points for U.S. equities, or some other amount suitable to the underlying securities and/or asset classes. More generally, any limit(s) or range(s) suitable for particular asset types and consistent with partial obfuscation of fund holdings may be used as a forecasted tracking error with the methods and systems described herein.

A variety of optimization tools are available for the analysis of financial assets. While these tools are conventionally applied to manage risk and expected returns, they may also be usefully adapted to generate substitute baskets meeting the constraints contemplated herein. In general, the substitute basket partially obfuscates holdings of a fund, while providing sufficient compositional similarity to facilitate in-kind transactions based on the substitute basket and sufficient similarity in pricing behavior to provide a useful signal of fund value during a trading day. At the same time, a basket generation tool will usefully permit a portfolio manager to over-represent or under-represent assets of the fund basket within the substitute basket. In one aspect, these competing constraints may be satisfied using an optimization that seeks to maximize a corresponding objective function. For example, a useful objective function may take the general form:

f(x)=k₁lₓ+k₂Lₓ+k₃Pₓ [Eq. 1]

where k₁ is an inclusion constant, Iₓ is the weighted average inclusion score (e.g., the product of the inclusion score and the weighting) for the x^{th} asset, k₂ is a liquidity constant, Lₓ is the liquidity metric (or inverse or negative of a transaction cost metric) for the x^{th} asset, k₃ is a penalty constant, and Pₓ is a sum of penalties for the x^{th} asset. This objective function may be optimized to maximize the objective function for a collection of assets, which may exclude some of the assets in the fund basket and which may include some assets that are not in the fund basket. Using these constraints, an optimizer may identify a set of active weights or adjustments to weightings of the fund basket to satisfy:

max Σₙ₌₁^{x}f(x) [Eq. 2]

for assets 1 through x in a group of assets in the fund basket while remaining within other constraints for the substitute basket as described herein. The penalty constant and the penalties may be used to implement soft constraints to impose selection preferences without using rigid requirements. For example, a substitute basket may have an active share maximum of 20%. In order to discourage approaching this limit, a linear penalty of one point for each percent of active share over 10% may be applied. In another aspect, including a negatively scored asset may incur a penalty score linearly related to a magnitude of the negative score. Any number of additional soft constraints may be realized using this penalty framework, and may guide the optimization toward desirable results. In one aspect, the optimizer may automatically select additional assets for replacement of assets in the fund based on, e.g., asset type, sector, currency, and so forth. In another aspect, a user may specify one or more replacement assets, e.g., by explicitly adding the assets to the fund with a current weighting of zero and adding an inclusion score indicative of a preference for including the corresponding asset in the substitute basket.

A factor analysis or the like may concurrently be used to maintain suitable category allocations, or the model may apply penalty scores to discourage selections outside the intended categories when optimizing the objective function.

In principle, any of a number of optimization techniques or optimization engines may be employed to maximize the weighted average inclusion score and meet the constraints above. A number of commercial alternatives exist for optimizing in a manner that controls risk contributions and uncertainties, controls exposure to countries, currencies, and industry sectors, and controls tracking errors, while also providing thresholds to limit or remove undesirably small positions from reported results. While such tools and techniques are known for use in problems such as, e.g., maximizing returns subject to a tracking error and linear constraints, these tools can be adapted to more specifically yield a high quality, highly correlated substitute basket as contemplated herein. In particular, a portfolio manager can maintain a predetermined level of (forecasted) correlation to the underlying fund by targeting a particular tracking error, while also controlling the amount of obfuscation of the underlying assets associated with the active share window. That is, the optimizer can maximize the weighted average inclusion score for the substitute basket while generating a predetermined amount of active share that contributes to the tracking error.

The foregoing techniques can usefully support the creation of a substitute basket meeting various constraints, and can advantageously be adapted to use any of a variety of commercially available financial/investment optimization tools. However, it will be understood by one of ordinary skill in the art that other techniques such as expert systems, machine learning, and the like, may also or instead be used to recommend weightings for a substitute portfolio meeting the various criteria described herein, and may be used alone or in combination with the techniques above to configure substitute baskets. All such techniques are intended to fall within the scope of configuring substitute baskets as described herein, unless a different meaning is explicitly provided or otherwise clear from the context.

As shown in step 306, the method 300 may include storing and publishing substitute basket information. The substitute basket may usefully be created and published before each trading day (for a market in the ETF shares) in order to ensure that the substitute basket is suitably aligned to the current fund holdings, and to ensure that the forecasted tracking error is within the desired target range. This substitute basket may be used, among other things, for market participants to value shares of the fund without receiving direct information about the composition of the fund.

It will be noted that the fund may provide other information in addition to the selection and weighting of assets in the substitute basket. For example, the method 300 may include publishing an indicative net asset value for the fund periodically, e.g., once per second, once every five seconds, or at least once every fifteen seconds throughout the trading day. The indicative net asset value may include an estimate of a value of the fund based on, e.g., the proxy portfolio, assets correlated to fund assets, reported asset prices, fair valuation estimates, or any other suitable data or valuation metrics.

The method 300 may also or instead include publishing a net asset value for the fund two or more times during the trading day for the market. Because the substitute basket may deviate from the fund value over the course of a trading day, the fund platform may usefully strike a net asset value for the fund multiple times during the trading day. This may impose administrative burdens on the fund, and as such, may most advantageously be performed a limited number of times, and preferably at times with the greatest market relevance. For example, the fund may include at least one asset traded on a secondary market that is closed for at least a portion of the trading day for the market, such as a foreign equity traded on a foreign stock exchange. If the foreign market closes at, e.g., 10:00 a.m., the net asset value for a fund that includes securities traded on that foreign market may usefully be calculated at 10:00 a.m., at or immediately after the close of the foreign market. Similarly, bond, currency, commodity, and futures markets may close at different times, and may suggest different NAV strike times according to the quantity and type of assets held by the fund. At the same time, one or more NAV strikes may usefully be calculated at about a midpoint of the remaining trading day, and/or at other intervals, to provide additional intraday opportunities for ETF creations or redemptions at a known NAV for the fund.

As shown in step 308, the method 300 may include monitoring performance of the substitute basket. For example, this may include receiving market data such as current asset prices and periodically calculating (and optionally publishing) a value of the substitute basket. This may also or instead include monitoring (and optionally publicly reporting) a deviation between the substitute basket and the fund basket during the trading day. In this context, the deviation generally refers to the divergence between the price of the substitute basket and the price of the fund basket (e.g., on a per share basis), although other terms such as “divergence” or “ex post tracking error” may also or instead be used to describe an instantaneous difference between a value of the fund basket and the substitute basket. More generally, a variety of benchmarks or metrics may be used in this context to indicate the difference between the return achieved by the substitute basket and the return achieved by the fund basket, and any such metric may usefully be published in this context to provide information for comparing the price performance of the substitute basket to the fund basket.

One concern for a substitute basket is that, despite modeling with the best available information and optimization engine(s), the substitute basket may deviate substantially from the fund basket (e.g., well beyond a forecasted tracking error of one standard deviation of historical error for the substitute basket) because of price variations specific to certain securities in the portfolio, changes in the fund composition, or other causes. In order to address these types of significant deviations, the method 300 may also include providing a signal for fund intervention when the daily tracking error exceeds a predetermined limit, such as a limit greater than the predetermined threshold, or greater than twice the predetermined threshold. A portfolio manager may respond by publishing a notification of the amount or cause of the deviation, or the underlying securities related to the deviation. The portfolio manager may also or instead deploy other remediations such as initiating an intraday revision to the substitute basket, updating the basis for calculating an indicative net asset value, updating the estimated tracking error, or otherwise providing information or revising calculations used by the market to value ETF shares.

As shown in step 310, the method 300 may include storing daily tracking error information. This information may be published and/or used internally by the fund in order to evaluate, over extended intervals such as weeks, months, and years, how accurately the substitute basket is tracking the fund basket.

FIG. 3B illustrates a user interface for creation of a substitute basket. In general, the interface 350 may include a portfolio selection tool 352, a number of basket action tools 354, a statistics display 356, and a basket creation window 358. The interface 350 may be rendered by a local application executing on a computing device and communicating with external resources such as the fund platform (for fund basket information) and a third party optimization engine (for calculation of adjusted weights). In another aspect, the interface 350 may be hosted on a remote platform such as the fund platform and locally rendered for a user in a web browser or other local client application or the like.

The portfolio selection tool 352 may provide a drop down list or other tool for selecting any of a number of portfolios to be managed in the interface 350. For example, a portfolio manager may log in to the fund platform through the interface 350, and receive access to any of a number of portfolios that the portfolio manager is responsible for, or that the portfolio manager otherwise has authority to review. In one aspect, the rights granted within the interface 350 may be user-dependent. For example, the list of available portfolios provided by the selection tool may depend upon the particular user, and interaction with the basket creation window 358, e.g., to adjust the inclusion scores or add assets for use in the substitute basket may depend on whether a user is authorized to make changes to the fund holdings or the substitute basket. Furthermore, while the present disclosure may emphasize creation of the substitute basket rather than management of the underlying fund, the interface 350 may also or instead include controls for modifying the selection and weighting of assets within the fund. While a drop down list is shown as the portfolio selection tool 352, it will be understood that any of a variety of other user interface tools or controls may be provided by the interface 350 for selection of a portfolio.

The basket action tools 354 may include any actions useful for managing a substitute basket for a fund as described herein. For example, the basket action tools 354 may include a tool to run a basket optimization, e.g., to generate a substitute basket based on a current selection of inclusions scores, or a tool to publish a basket, e.g., once a substitute basket has been created that satisfies the portfolio manager or other personnel. The basket action tools 354 may be realized as buttons or other controls within the interface 350.

The statistics display 356 may present statistics for a current substitute basket that has been created by a basket optimization engine accessed through the interface 350. The statistics display 356 may, for example, present descriptive statistics or other statistical data or metrics for the substitute basket including data provided by the basket optimization engine, data calculated by the fund platform, or any other data from any other source or combination of sources.

By way of non-limiting examples, the statistics display 356 may present an active share of the substitute basket relative to the fund basket. As used in the financial industry, the active share is determined by summing the absolute value of differences between the weight of each holding in a portfolio and a benchmark. For a portfolio with N components, this may be expressed as:

Active Share=½Σᵢ₌₁^{N}|W_{f,i}−W_{b,i}| [Eq. 3]

Where W_{f,i} is the weight of the i^{th} component in the fund, and W_{b,i} is the weight of the i^{th} component in the benchmark, and the active share is reported as a percentage. In general, the active share is a useful metric for measuring the relationship between a portfolio and a benchmark, and is commonly used in the financial industry to express the degree to which an active manager is deviating from the underlying benchmark in an effort to secure greater returns, adjust risk, or some combination of these. As contemplated herein, this metric is used instead to directly control the amount of difference between the public-facing substitute basket and the non-disclosed fund basket within a specific window, more specifically so that the fund basket maintains a controlled degree of obfuscation to shield active management decisions while still reflecting the composition of the fund closely enough to provide a useful pricing signal to the secondary market and support ETF share transactions such as hedging and in-kind creation/redemption in the primary market.

In another aspect, the statistics display 356 may present a forecasted tracking error (also referred to herein as an “estimated tracking error”), which may be expressed, e.g., in a dimensionless value such as basis points relative to the underlying portfolio. As used in the financial industry, the historical tracking error is commonly calculated as the standard deviation of the difference between returns of a portfolio and a benchmark over time:

$$TE = \sqrt{\frac{{\sum }_{i = 1}^{n} {( {R}_{p} - {R}_{b} )}^{2}}{n - 1}} \qquad [ Eq . 4 ]$$

Where TE is the tracking error, Rₚ is the portfolio return, R_{b} is the benchmark return (and Rₚ−R_{b} is the active return for the portfolio relative to the benchmark), and n is the number of time periods over which the tracking error is calculated. This historical tracking error (also referred to as the realized or ex-post tracking error) is conventionally used to measure the historical performance, e.g., the relative success of active management versus a benchmark, and may be used in the context of substitute basket creation to evaluate whether a particular basket has historically tracked well with a fund basket (e.g., the historical tracking error is small).

However, the forecasted tracking error (also referred to as an estimated tracking error, predicted tracking error, or ex-ante tracking error) may provide a better metric for whether a substitute basket is likely to track with the fund basket over the course of an upcoming trading day. Various types of ex-ante tracking error models are used in the financial industry, and/or commercially available from third party providers, many of which may be useful in calculating a forecasted tracking error for a substitute basket as contemplated herein. The ex-ante tracking error can be evaluated using models that range from simple equity models to complex multi-factor models. For example, a simple model may use beta (a ratio of covariance of an asset and the index to the variance of the index) to measure the risk relative to a broader market such as an index or other diversified portfolio. A more complicated multi-factor model may evaluate the risk based on unobserved random variables (referred to as “common factors”) that appear to influence the observed random variables.

An ex-ante tracking error may be calculated locally by the fund platform or with the assistance of third party optimization engines or the like. While this value is conventionally used in the financial industry to evaluate and manage risk, the ex-ante tracking error also provides a useful tool for evaluating substitute baskets as described herein. In particular, the ex-ante tracking error provides a useful metric for a substitute basket because the ex-ante tracking error indicates an amount that the substitute basket is expected to vary from the fund basket over the course of an upcoming trading day. Thus, the tracking error more generally serves as a figure of merit (or more precisely, the inverse of a figure of merit) for expected pricing accuracy, with a low ex-ante tracking error suggesting that, based on a multi-factor or other analysis, that the substitute basket will closely track the fund basket. The tracking error may be calculated for a particular substitute basket and displayed within the statistics display 356.

The statistics display 356 may also or instead show relative weightings of the substitute basket to the fund basket. For example, the statistics display 356 may show a basket weight of assets with negative inclusion scores. As noted herein, a negative inclusion score may indicate that a portfolio manager wishes to exclude a stock or other asset from the published substitute basket. Thus, a portfolio manager who has negatively weighted an asset may wish to check that little or none of that asset appears in the substitute basket, as reflected by a correspondingly low or zero basket weighting. Thus more generally, the portfolio manager may receive an indicator of whether negative inclusion scores are yielding the desired impact on asset weightings. Similarly, the statistics display 356 may show a fund weight of negatively scored assets, which may facilitate an immediate visual comparison of the fund basket to the substitute basket with respect to the negatively weighted stocks.

The basket creation window 358 may permit a portfolio manager to dynamically enter, and evaluate the results of, inclusion score selections. In one aspect, the basket creation window 358 may use a spreadsheet or similar structural metaphor in which assets are listed in rows, and features such as a description, an inclusion score, a basket weight, a fund weight, an active weight, and a contribution to the specific risk are displayed in tabular form. The basket creation window 358 may be an active window with numerous user controls available.

For example, a user such as a portfolio manager may have the ability to add new rows, which may permit the addition of new assets to the fund basket, or may permit the addition of new assets to the substitute basket that are not in the fund holdings. A column for the inclusion score may default to a weight of one, or some other suitable value indicating a neutral weight, for all assets when a portfolio is loaded into the interface 350, or the inclusion score may default to a most recent prior scoring or a last save scoring for the portfolio. The inclusion scores may be adjusted by a user within the inclusion score column in order to reflect discretionary intent to underweight or overweight assets in the corresponding substitute basket. When a basket optimization is selected from the basket action tools 354, the weights of the assets in the fund basket may be adjusted as described herein to obtain a substitute basket having a target active share and a target tracking error, and/or meeting other constraints for the substitute basket. For each asset, e.g., for each row in the basket creation window 358, a column may be provided for system input values such as the current fund weight, user input values such as the inclusion score, output from an optimization engine or the like such as the substitute basket weight, and locally calculated values such as an active weight representative of a difference, for each asset, between the weighting in the fund basket and the weighting in the substitute basket.

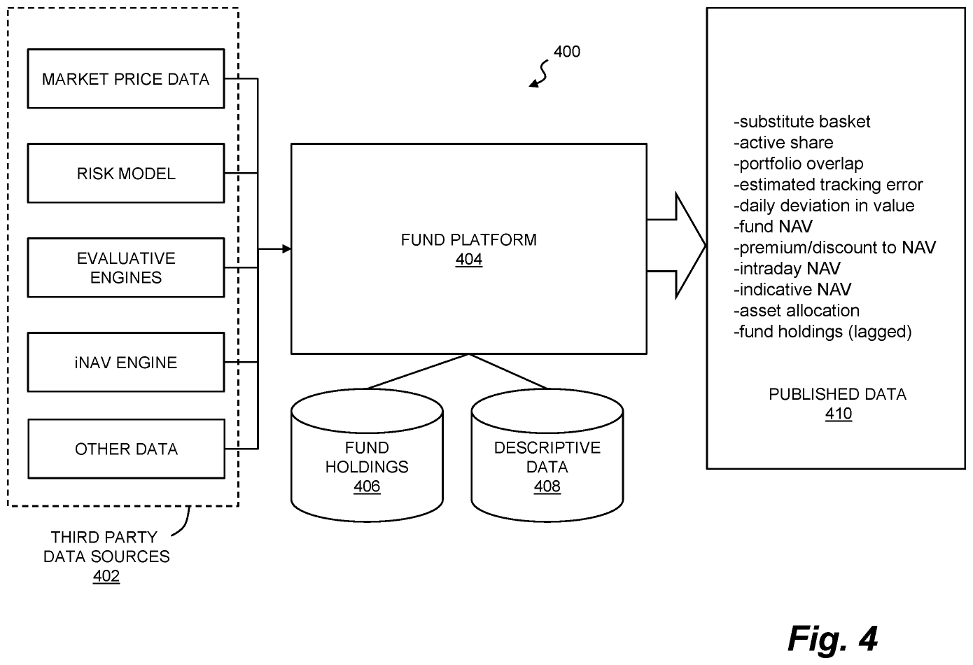

FIG. 4 illustrates a system for publishing valuation information. One of the purposes of the substitute basket described herein is to shield the selection and weighting of assets in the fund from public disclosure. In order to facilitate trading in ETF shares for the fund, other alternative pricing information may be published so that market participants can accurately price or estimate the value of shares.

The system 400 may include a variety of third party data sources 402 that provide information useful for estimating the value of the non-disclosed portfolio. For example, this may include market price data (for fund assets and substitute basket assets), risk models that can forecast tracking error, identify correlated assets for valuation, and so forth, evaluative engines, indicative net asset value engines, and the like. For example, an evaluative engine may be used to estimate the value of assets listed on markets (e.g., foreign markets) that are not active during the trading day for ETF shares or markets that do not publish or report transaction activity or prices during the trading day for the ETF shares (such as many fixed income securities). As another example, an indicative net asset value engine may be configured to calculate an estimate of the fund NAV based on, e.g., correlated assets or any other suitable proxies for fund component values (such as ETFs for the like for country, sector, currency, capitalization weighting, factor, style, and so forth, as well as derivatives, American Depositary Receipts, and so forth). The third party data sources 402 may include these and any other data sources, calculation engines, and the like that may be useful in pricing calculations for ETF shares.

The fund platform 404 may receive data from the third party data sources 402, and may store this along with internally generated data such as fund holdings 406 and descriptive data 408 for the fund holdings 406 such as the composition of the substitute basket, the active share or portfolio overlap, an estimated tracking error, and so forth. It will be understood that financial data used by the fund platform 404 as described herein may also or instead be generated or provided directly by the fund platform 404 and/or the descriptive data 408 maintained by the fund platform 404. The fund platform 404 may also or instead store other information related to pricing of, or transactions in, fund shares. For example, the fund platform 404 may store (and optionally publish) bid-ask spread information, all baskets of ETF shares trading in secondary markets, and any other information required by regulatory agencies, market participants, and so forth.

This data may be published on a publication platform (where example published data 410 is included on the platform in the figure), which may be a single platform such as a website hosted by the fund platform, or a combination of platforms. For example, certain information such as a substitute basket for use in ETF creations and redemptions may be provided to the National Securities Clearing Corporation or Depositary Trust Company, which may in turn forward the information to the public markets before each trading day. In general, the published data 410 may include the substitute basket. In addition to the substitute basket, a characteristics file with additional information may be disclosed to market participants to help efficiently price the portfolio intraday. The information contained in the characteristics file may include, but is not limited to: industry allocation, sector allocation, currency allocation, currency hedge, country allocation, asset class allocation, market cap allocation, factor exposures, liquidity, yield, duration, convexity, credit quality, maturity bands, yield spread, ex-ante tracking error between the underlying portfolio and the substitute basket, holdings differentiation (active share, portfolio overlap, etc.) between the underlying portfolio and the substitute basket, the historical tracking error between the underlying portfolio and the substitute basket, correlations to other ETFs, futures, ADRs, and other instruments. The data may also or instead include currency disclosures such as the amount and currencies of the underlying portfolio or any related currency hedges.

Other information may also or instead be included in the published data 410. For example, the fund platform may strike a net asset value for the fund one or more times during the trading day, e.g., at 10:00 a.m., 1:00 p.m., and 4:00 p.m., or at any other practical intervals, and this information may be published by the fund platform or through any other suitable channel. The actual NAV provides highly useful pricing information because it is known to accurately reflect the true price of the underlying securities. However, a full NAV strike is operationally difficult, and it may not be practical to strike a NAV frequently during each trading day. To provide additional market information, an indicative net asset value, or “iNAV”, for the fund may be calculated at much more regular intervals, such as once per second, once every five seconds, and so on. The iNAV may, for example, be based on an actual or estimated value of fund assets, the value of one or more correlated assets (e.g., where a current value of an asset is not immediately available), a midpoint for a national best bid and offer or one or more of the securities in the fund, or some combination of these or other metrics or assets providing useful indicators of the value of fund assets. While an iNAV that relies on assets other than the fund holdings may deviate from the actual fund NAV, such an iNAV can nonetheless rely in part on correlated assets (for which real time price information is available) to reduce those deviations. This may be particularly advantageous where the ETF includes assets that are not traded during at least a portion of the trading day for the ETF shares. For example, if the ETF holds foreign securities, a real time price may not be available, and a proxy such as an American Depositary Receipt may be used as a close alternative for calculating an iNAV. The net asset value for the substitute basket may also or instead be periodically calculated and published through any suitable medium. In another aspect, the net asset value for the substitute basket may be periodically calculated and published through any suitable medium.

The published data 410 may also or instead include other information useful for comparing the substitute basket to the fund basket or otherwise estimating the value of the fund basket. For example, a deviation between the net asset value for the substitute basket and the NAV or iNAV may be periodically calculated and published. In another aspect, an estimated premium or discount of the substitute basket to the fund basket, or of the ETF shares to the value of the fund basket, may be calculated and published. In another aspect, the fund may periodically publish the fund composition including the selection and weighting of financial assets held by the fund. This may occur on any suitable schedule such as once per month or once per quarter, and the published holdings may be lagged by an amount of time appropriate to protect against disclosure of the current holdings (e.g., on a thirty-day lag). For example, for monthly disclosures, the holdings disclosed on the last day of a month may be the holdings as of the first day of the month, or a midpoint of the month. This provides periodic disclosures of the complete fund holdings suitable for a general evaluation of the fund holdings and strategy, without requiring a disclosure of trading strategies in real time.

The published information may be used by market participants such as APs, market makers, and individual or institutional investors to estimate ETF share prices without knowing the complete selection and weighting of assets in the fund.

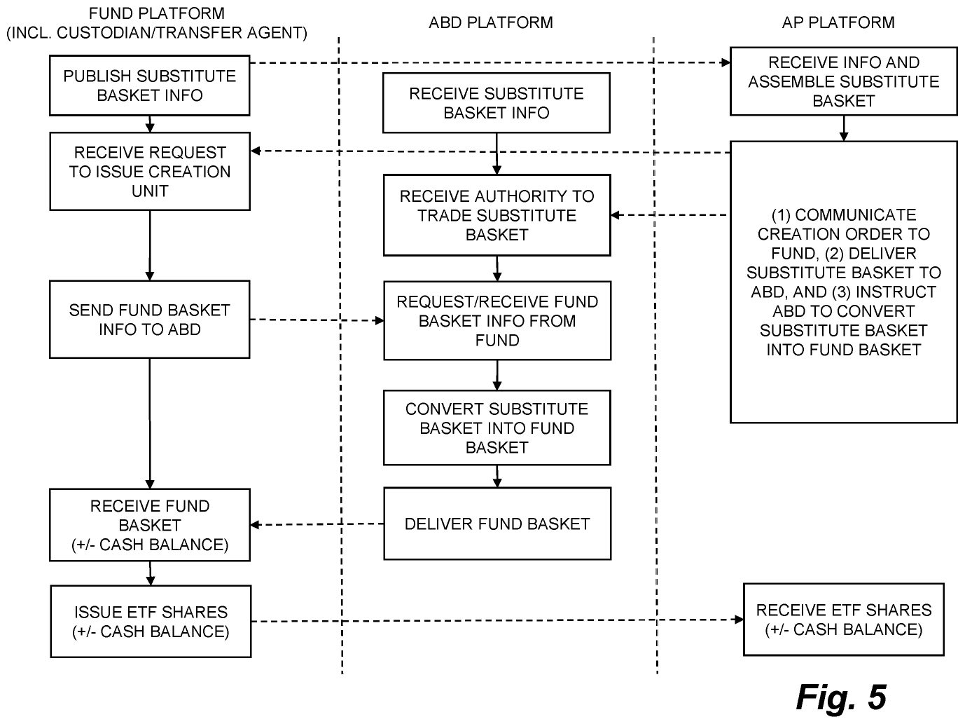

FIG. 5 illustrates a method for creating exchange-traded fund shares using a substitute basket. In general, an AP can receive substitute basket information from the fund, assemble the substitute basket, and then exchange this for a creation unit of ETF shares through the ABD platform, which receives the substitute basket and converts it into the fund basket for in-kind exchange with the fund platform. In this process, the AP platform may more specifically communicate a creation order to the fund, deliver the substitute basket to the ABD platform, and instruct the ABD platform to convert the substitute basket into the fund basket. It will generally be noted that due to transaction costs, timing differences and other factors, there may be a cash balance due to the AP or the fund, and this may be paid or collected as appropriate to close the transaction. It should also be noted that, while the fund basket will be a pro rata mirror of the fund composition if the fund is static, this is not necessarily always the case. Where the portfolio manager intends to make changes to the fund, the fund basket used in the creation process may be selected to effect some or all of the portfolio manager's intended reconstitution of the portfolio.

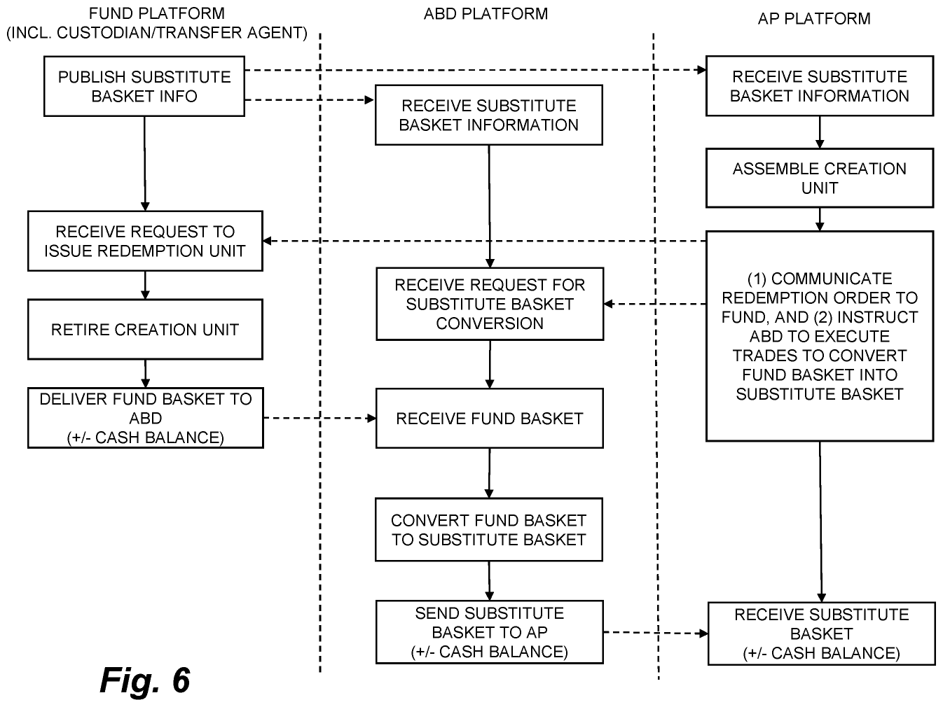

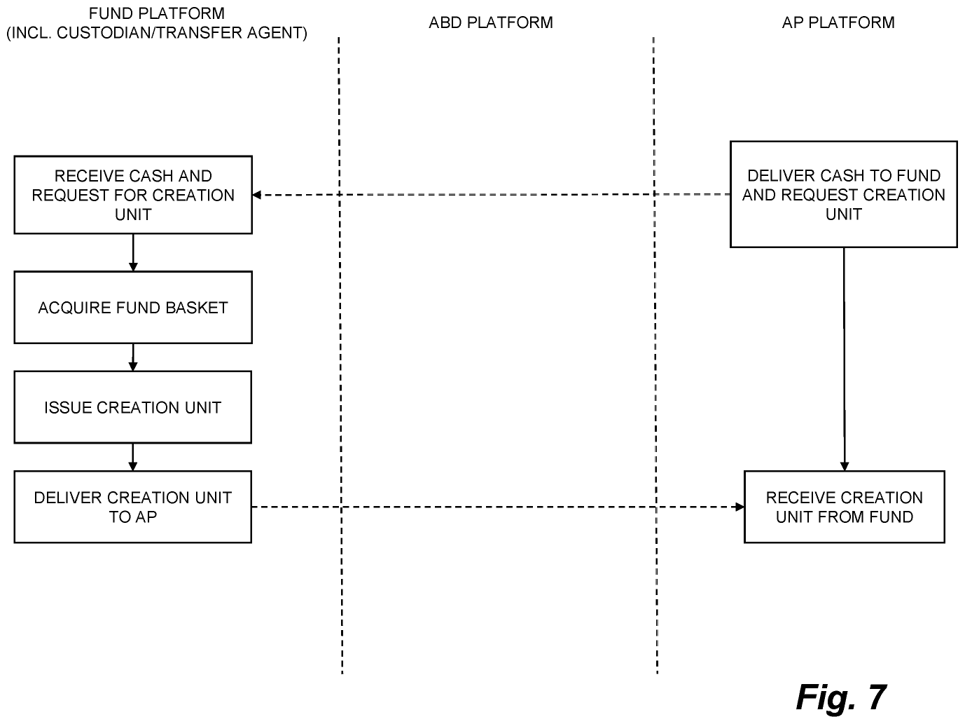

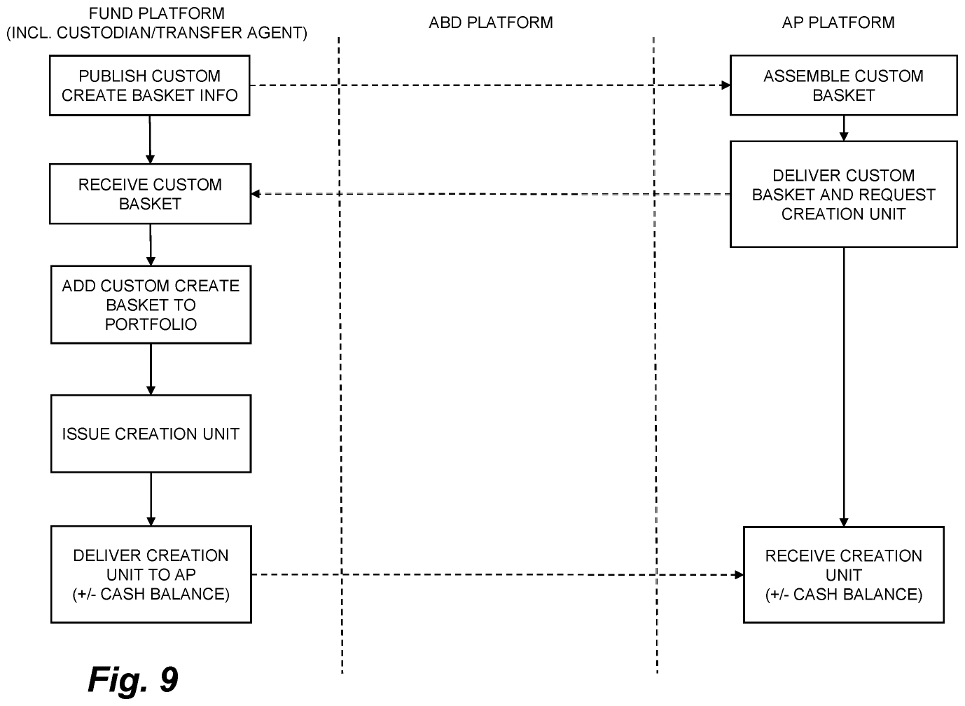

It will be understood that, while the substitute basket can usefully facilitate an AP-initiated creation of ETF shares based on a collection of securities having a substantial overlap with the fund basket (e.g., through the ABD), other techniques may also or instead be used. For example, an AP may also or instead initiate a cash creation as illustrated in FIG. 7 or a custom basket creation as illustrated in FIG. 9. In another aspect, the availability of substitute basket transactions (either for creation, or for redemption as described with reference to FIG. 6 below) may depend on the time of day at which the transaction is initiated. For example, the net asset value for the fund may be calculated at certain times, e.g., at 12:00 noon and 4:00 p.m., or at 10:00 a.m., 1:00 p.m., and 4:00 p.m. during the trading day. In this case, an AP may request a creation (or redemption) using the substitute basket type before, e.g., the 1:00 p.m. NAV strike. In this case, the transaction can be priced with a substantially contemporaneous assessment of the fund value. As long as the ABD can convert between the substitute basket and the fund basket relatively quickly thereafter, the AP should have a limited risk exposure that can be suitably hedged, resulting in relatively small spreads and efficient transactions. As an additional advantage, the risk exposure is also directly managed and limited by controlling the active share of the substitute basket relative to the fund basket as described above. However, for transactions that occur later in the trading day, where an actual NAV will not be determined again until the close of trading, transactions may be limited to cash transactions in order to prevent an AP from assuming overnight or other long term market risk. More generally, an ETF may usefully establish different cutoff times for different types of create and redeem orders, as well as for different types of assets (e.g., fixed income instruments, or foreign market securities), all without departing from the scope of this disclosure. For example, the fund may honor requests for conversions between substitute baskets and ETF shares that are received at least one hour before any NAV strike, at the price determined by that NAV strike.

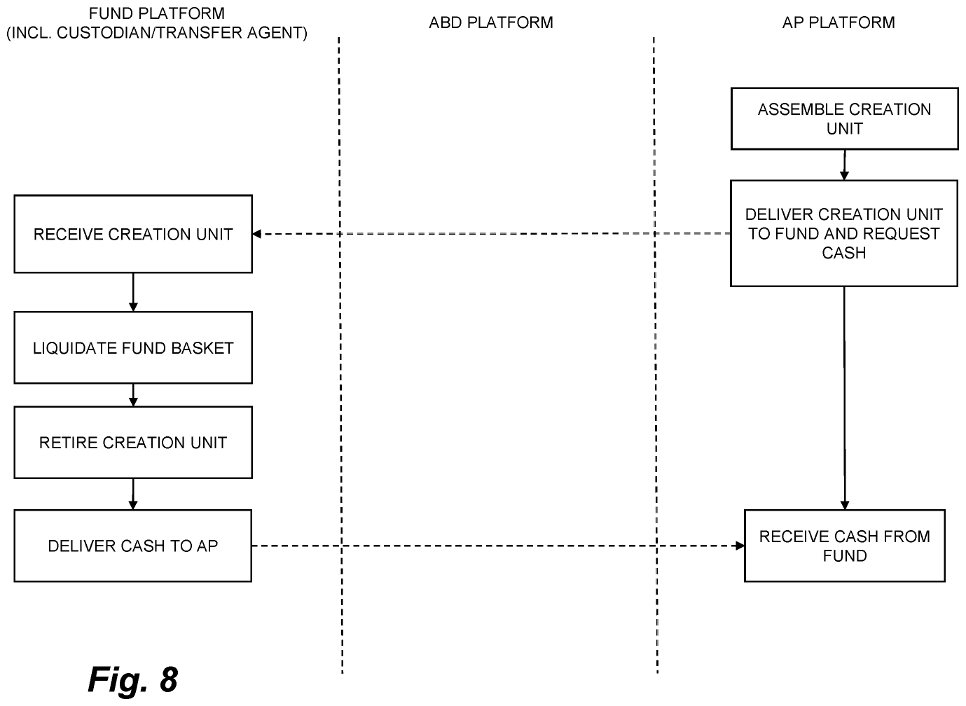

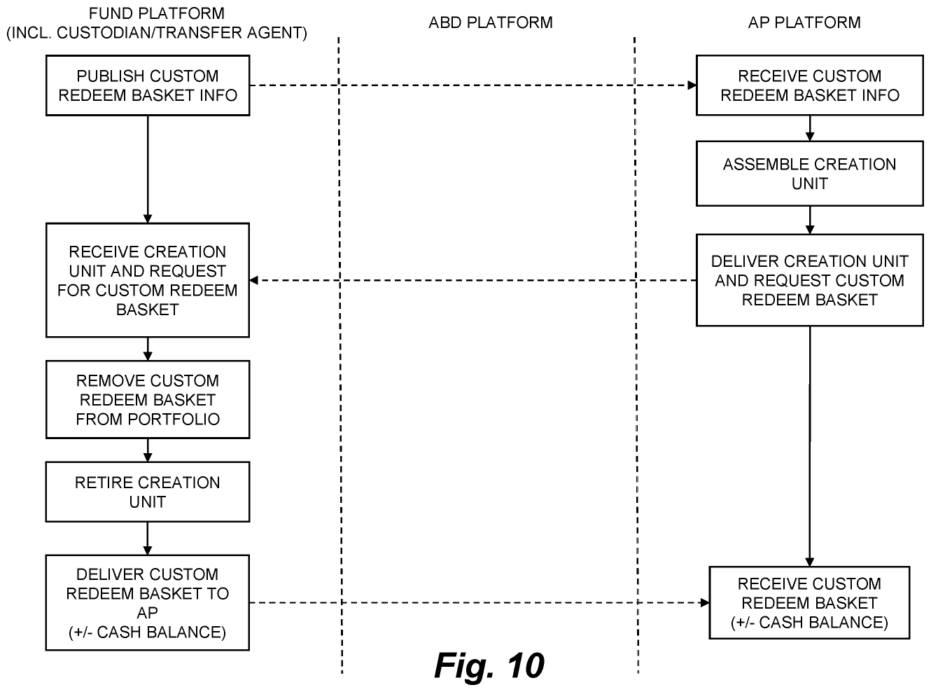

FIG. 6 illustrates a method for redeeming exchange-traded fund shares using a substitute basket. At a high level, the AP platform provides ETF shares to the fund in exchange for the substitute basket. In order to facilitate this transaction without revealing the composition of the fund basket, the ABD platform may receive the fund basket from the fund platform and convert the fund basket into the substitute basket for delivery to the AP platform. To initiate this process, an AP platform can receive substitute basket information from the fund and assemble a creation unit of ETF shares, either from the APs own inventory or the secondary markets, or some combination of these. The AP platform may then communicate a redemption order to the fund and instruct the ABD platform to execute trades to convert the fund basket into the substitute basket. As with ETF share creation as described above, the composition of the fund basket may deviate from the portfolio composition in a manner that purposefully adds securities to, or removes securities from, the fund portfolio. It will be understood that, while the substitute basket can usefully facilitate an AP-initiated redemption of ETF shares based on a collection of securities having a substantial overlap with the fund basket, other techniques may also or instead be used. For example, an AP may also or instead initiate a cash redemption as illustrated in FIG. 8 or a custom basket redemption as illustrated in FIG. 10.

FIG. 7 illustrates a method for creating exchange-traded fund shares using cash. In a cash creation process, the AP will generally provide cash directly to the fund platform (or to a custodian for the fund) and request a creation unit of ETF shares. The fund platform may then acquire the fund basket (e.g., through the custodian), issue a creation unit, and deliver the creation unit to the AP platform (e.g., through a transfer agent). It will be noted that the ABD platform is not generally needed during a cash creation because the fund can acquire the necessary securities directly, and the selection and weighting of assets in the fund basket would not be exposed to the AP platform.

FIG. 8 illustrates a method for redeeming exchange-traded fund shares using cash. In a cash redemption process, the AP platform may assemble a creation unit, e.g., by acquiring a corresponding number of ETF shares on the secondary markets, and delivering the creation unit to the fund platform along with a request for cash. The fund platform may liquidate a fund basket (and receive a corresponding amount of cash), retire the creation unit, and deliver the cash resulting from the liquidation to the AP platform. Alternatively, where the fund has sufficient cash reserves, the redemption may be paid to the AP in whole or in part from cash reserves without liquidating any securities. As with a cash creation, in an aspect, in a cash redemption process the AP platform is never exposed to the fund basket, so there is no need for the AP to transact through an ABD platform.

FIG. 9 illustrates a method for creating exchange-traded fund shares using a custom basket of securities. Under certain circumstances, such as where the fund is adjusting the composition of the fund portfolio, the fund may offer creation transactions to APs using a custom create basket. For example, if the fund wishes to add a particular stock to the portfolio, the fund platform may publish one or more custom create baskets that include that particular stock, either alone or in combination with other securities, and the fund platform may invite create transactions from APs using these custom baskets. In the event that an AP wishes to transact based on one of the custom baskets, the AP platform may assemble the custom basket by acquiring the corresponding securities in the secondary markets, from the APs inventory, or some combination of these. The AP platform may deliver the securities in the custom basket to the fund platform and request a creation unit. Each custom basket fashioned in this manner will provide only limited information about the selection and weighting of assets in the fund, so a custom basket creation may optionally be performed between the AP platform and the fund platform without any need for an ABD or other mechanism to shield information about the fund portfolio.

FIG. 10 illustrates a method for redeeming exchange-traded fund shares using a custom basket of securities. Under certain circumstances, such as where the fund is adjusting the composition of the fund portfolio, the fund may offer redemption transactions to APs using a custom redeem basket. For example, if the fund wishes to remove a particular stock from the portfolio, the fund platform may publish a custom redeem basket that includes that particular stock, either alone or in combination with other securities. The fund platform may publish this redeem basket, and invite redemptions by APs using the redeem basket. In the event that an AP wishes to transact based on the custom basket, the AP platform may assemble a creation unit of ETF shares, e.g., by acquiring the ETF shares in a secondary market, and delivering the creation unit to the fund platform along with a request for the custom redeem basket. The fund platform may remove the securities in the custom redeem basket from the fund portfolio, and deliver the securities in the custom redeem basket to the AP platform. The custom redeem basket will provide only limited information about the selection and weighting of assets in the fund, so the custom basket redemption may be performed between the AP platform and the fund platform without any need for an ABD to shield information about the fund portfolio.

Other basket creation or redemption techniques may also or instead be employed. For example, in one aspect, the basket creation or redemption may use a negotiated basket, which may be created through a negotiation process between an AP and a fund prior to the creation/redemption transaction. The AP and the fund may, through a series of communications, agree on a negotiated basket that includes any mutually agreeable assets including assets held by the fund, assets that are not held by the fund, assets the fund wishes to dispose of, assets the fund wishes to acquire, cash, or any combination of these. Once the contents of this negotiated basket have been agreed to by the AP and the fund, a creation or redemption may occur using the techniques described above.

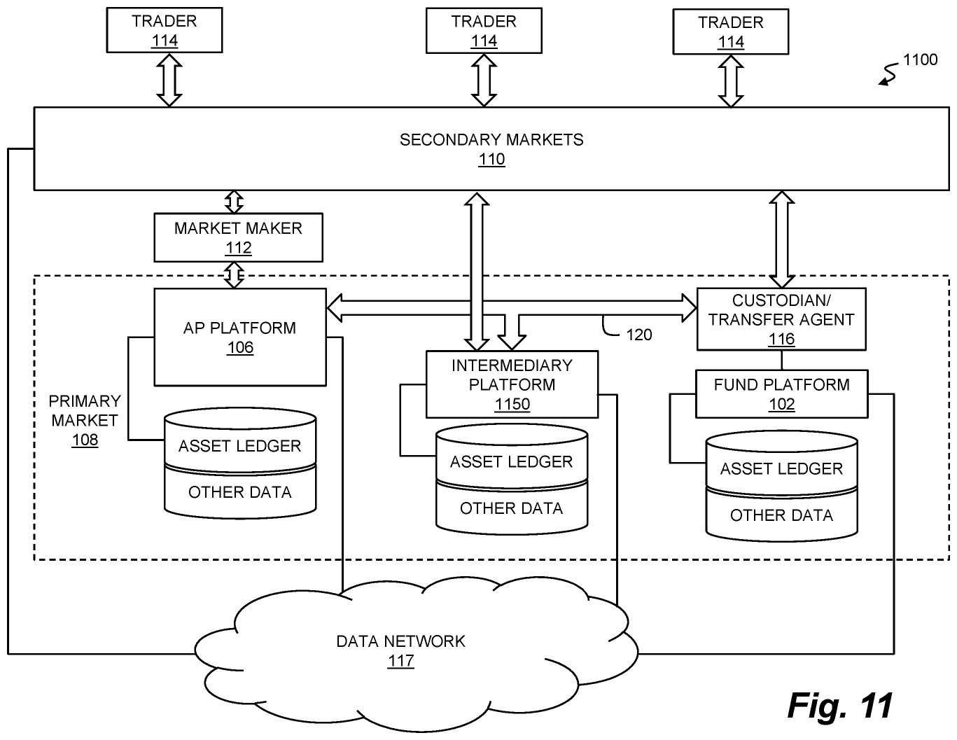

FIG. 11 is a block diagram of a computerized system including an intermediary for transacting in exchange-traded funds. In general, the system 1100 may include any of the systems and corresponding entities, platforms, and the like described herein, and thus the same reference numbers for these components or entities may be used in the system 1100 of FIG. 11 that are used to describe other systems herein such as the system 100 shown in FIG. 1. Turning back to FIG. 11, in an aspect, the system 1100 may include an intermediary platform 1150 for one or more intermediaries that facilitates transactions between the fund platform 102 that sponsors a fund and the authorized participant platform 106 that provides an interface between the fund and secondary markets 110 for traders 114.

The intermediary platform 1150 may be managed by any of the intermediaries described herein, such as an affiliated broker-dealer. However, it will be understood that a variety of other intermediaries may also or instead be employed without departing from the scope of this disclosure. For example, the intermediary platform 1150 may be operated by a third party representative that is authorized to act on behalf of (but otherwise unaffiliated with) a fund and/or authorized participant. The third party representative may facilitate creation and redemption of shares in an exchange-traded fund by confidentially receiving (but not publishing or otherwise exposing) a description of fund holdings that can be used by the intermediary platform 1150 to obtain and deliver underlying securities as needed. This may, for example, include transacting with the fund platform 102 using the fund basket as described in a confidential file, or described in any other data describing the fund holdings. This may also include transacting with the authorized participant platform 106 using a creation basket published by an investment company that operates the fund platform 102.

In one aspect, the intermediary platform 1150 may be operated by a licensed or otherwise authorized broker-dealer, e.g., a broker-dealer that is, in the United States, a member of the Financial Industry Regulatory Authority (FINRA), or any other similar licensing, monitoring, or regulatory authority. More generally, the broker-dealer may be any licensed broker, third-party broker-dealer, affiliated broker-dealer, or other party licensed (or otherwise authorized) and competent to transact in securities or otherwise suitable to function as an agent for transactions as described herein.

In another aspect, the intermediary platform 1150 may be removed, and the AP platform 106 may transact directly with the fund platform 102 (e.g., via a custodian and/or transfer agent 116 for the fund). In another aspect, the fund may provide the option of transacting directly with APs (e.g., using a substitute basket or the like), while also permitting any other intermediaries to participate in such transactions, subject to suitable confidentiality agreements, as required by the nature of the baskets used by the intermediaries. This hybrid approach may advantageously permit a fund to closely control the costs and execution of transactions associated with create/redeem events, while also creating a market for potential intermediaries who can find ways to more cheaply or efficiently broker such transactions. In this hybrid approach, the fund may also optionally reserve certain protected trades that are believed to contain sensitive information about the composition or trading activity of the underlying fund. The fund may also or instead intermittently establish blackout periods during which all creation/redemption activity must be conducted directly with the fund.

To facilitate any of the above transactions, the fund platform 102 may use any suitable create or redeem baskets to shield holdings of the fund from disclosure, including any of the substitute baskets, custom baskets, fund baskets, or other alternative baskets described herein or otherwise useful for shielding fund holdings from disclosure during transactions, as well as combinations of the foregoing. While a substitute basket may usefully be optimized using the techniques described herein, it will also be understood that a substitute basket may usefully employ any technique suitable for facilitating hedging or arbitrage, as well as effective pricing mechanisms, during the creation and redemption of ETF shares while shielding actively managed holdings from public disclosure during such transactions. For example, a substitute basket may be purposefully constructed to contain one hundred percent of the fund holdings, but using a different weighting than the fund for individual securities. The substitute basket may also or instead employ a randomly generated overlap (within a target percentage range of, e.g., 80-90%, 90-100%, or some other suitable range) between the weighting of securities in the substitute basket and the weightings in the fund portfolio. Other targets may also or instead be used, such as a minimum overlap percentage with the fund portfolio. In another aspect, the substitute basket may use other ETFs that correspond to the fund portfolio's overall exposure in order to improve tracking of the fund's value while reducing the corresponding disclosure of actual fund holdings. In another aspect, separate baskets may be used for pricing (e.g., a reference basket that seeks to minimize variations from the fund share price) and transactions (e.g., a create or redeem basket that seeks to minimize variations from the fund holdings). This approach may facilitate improved hedging or pricing by reducing risks between the known reference portfolio and an unknown fund portfolio. More generally, any technique that sufficiently approaches true price movement to facilitate transactions by authorized participants (or other market participants), while shielding some or all of the holdings of a fund, may be used to create substitute baskets as described herein.

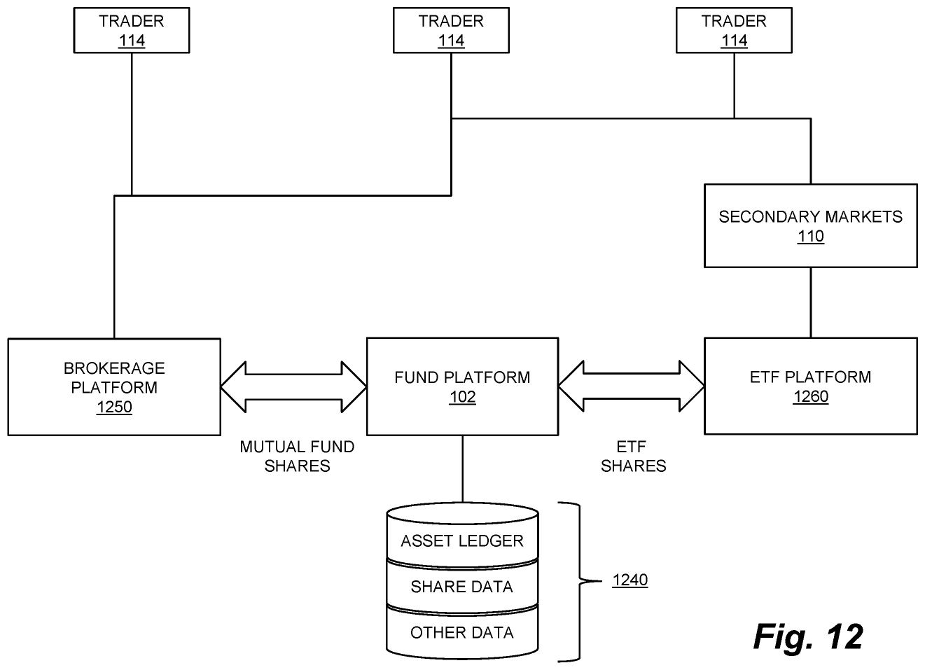

FIG. 12 shows a system for managing a fund with multiple share classes. In general, a fund may use a fund platform 102 to manage a portfolio of investment assets, and to manage the purchase and sale of shares in the portfolio between the fund and traders 114. The traders 114 may generally be any of the investors described herein, including individual investors, institutional investors, and so forth. While the traders 114 may buy and sell exchange-traded fund shares on the secondary markets 110 (e.g., through a broker) as described above, the traders 114 may also or instead purchase mutual fund shares in the same fund of assets directly from a fund, or from a brokerage or the like that transacts in the mutual fund shares on behalf of the fund.

In general, the fund platform 102 may include any of the fund platforms described herein. The fund platform 102 may generally include, or have connections or relationships with, market entities that can buy and sell publicly traded securities and other investment assets on behalf of the fund. The assets comprising the net asset value of the fund may be recorded in one or more asset ledgers in a database 1240 maintained by the fund. The database 1240 may also or instead store share data including the number and type of outstanding shares in the pool of assets owned by the fund. This may include exchange-traded fund shares, e.g., as described herein, which are typically sold in fixed creation units through an authorized participant or the like, and then traded in secondary markets 110 such as public stock exchanges. The shares in the fund may also or instead include mutual fund shares or other shares of the pool of assets owned by the fund that can be bought and sold in direct transactions with the fund, or in transactions with a broker on behalf of the fund. The database 1240 may also store other data, such as substitute basket composition, net asset value, net asset value indicators or estimates, tracking errors, or any of the other metrics, pricing information, or other data that might be used to manage the fund and/or provide pricing information to public markets as described herein. It will be understood that, while illustrated as a single database, the database 1240 may include a federated database, one or more individual databases, or any other number and arrangement of databases or other data repositories suitable for reliably storing fund data and timely responding to corresponding queries.

An ETF platform 1260 may include any of the exchange-traded fund platform components described herein. The ETF platform 1260 generally facilitates the creation and redemption of ETF shares representing proportional interests in the basket of assets held by the fund. More specifically, under certain conditions, new ETF shares may be created and issued through the ETF platform 1260 into the secondary market 110 where the ETF shares can be bought and sold by traders 114. In general, these issued ETF shares may be bought and sold as long as the corresponding secondary markets 110 are open. Under other, complementary conditions, ETF shares may be redeemed and removed from the secondary market 110 using the ETF platform 1260.

The brokerage platform 1250 may facilitate a variety of different distribution channels for other fund share classes, such as any of a variety of mutual fund shares or the like. This may include direct transactions between the fund (or fund platform 102) and traders 114, e.g., where the traders 114 are individual or institutional customers of the fund. This may also or instead include transactions that are brokered by another institution, e.g., where a trader 114 wishes to acquire shares in the fund but does not have a pre-existing commercial relationship with the fund. While ETF shares are typically purchased on demand during the operating hours of any corresponding secondary market(s) 110, mutual fund shares orders are executed at the end of a trading day, with a price based on the end-of-day net asset value for the fund.

Fund shares distributed through the brokerage platform 1250 may include a number of different share classes that are organized, e.g., according to investment size, sales fees, and so forth. For example, the fund shares may include different shares for individual investors and institutional investors, each having different minimum investments. Other share types or share classes may focus on particular attributes such as shares that have no sales load (whether front-loaded, back-loaded, or level-loaded), shares with low net expense ratios, shares for institutional investors (e.g., with high minimum investment amounts), shares with waived loads, or shares for use in retirement funds.

In a typical fund structure, a fund may include A shares that charge an upfront sales fee (typically along with lower marketing and distribution fees), B shares that charge a back-end or contingent deferred sales charge (typically along with higher expense ratios), and C shares with a back-end load that may be waived if the shares are held for a sufficient period. The different share classes may have other features. For example, B shares may automatically convert to A shares after a specific holding period, thus incurring the lower annual expenses associated with the A shares. More generally, any combination of share classes and share attributes may be used to transact in representative shares of a fund's holdings, subject of course to approval and oversight by any applicable regulatory authorities. All such share classes in a fund may be bought and sold through a brokerage platform 1250 instead of, or in addition to, exchange-traded fund shares for the fund, and all such share classes may be used by a fund platform 102 to manage shares in a portfolio as contemplated herein.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. A system comprising:
an authorized participant platform hosted by an authorized participant and operable to participate in a secondary market for shares in an exchange-traded fund;
an investment company platform hosted by an investment company, the investment company actively and non-transparently managing a fund including a selection and weighting of financial assets according to a proprietary investment strategy, wherein the investment company platform is configured to periodically publish information about the fund including a substitute basket correlated to a value of the fund without disclosing the selection and weighting of the financial assets held by the fund; and
a third party platform interposed between and coupled in a communicating relationship with the authorized participant platform and the investment company platform, the third party platform configured to facilitate creation and redemption of shares in the exchange-traded fund by executing in-kind exchanges with the authorized participant platform of the substitute basket for shares equal to a creation unit of the exchange-traded fund and by executing in-kind exchanges with the investment company of a fund basket having the weighting of financial assets in the fund for the creation of the exchange-traded fund, wherein the third party platform is configured to execute trades to convert between the substitute basket and the fund basket, and wherein the third party platform prevents disclosure of the fund basket to the authorized participant.

2. The system of claim 1 wherein the third party platform is a broker platform.

3. The system of claim 1 wherein the third party platform is operated by a third party independent from the authorized participant and the investment company.

4. The system of claim 3 wherein the third party receives a confidential description of the fund including the selection and weighting of financial assets.

5. The system of claim 1 wherein the third party platform transacts with the investment company platform using the fund basket, and wherein the third party platform transacts with the authorized participant platform using the substitute basket.

6. A system comprising:
an authorized participant platform hosted by an authorized participant and operable to participate in a secondary market for shares in an exchange-traded fund;
an investment company platform hosted by an investment company, the investment company actively and non-transparently managing a fund having a composition including a selection and weighting of financial assets determined according to a proprietary investment strategy, wherein the investment company platform is configured to periodically publish information about the fund including at least:
(a) a substitute basket containing assets overlapping with the financial assets held by the fund and selected and weighted to have a substitute value correlated to the composition of the fund without revealing the composition of the fund,
(b) at least once daily, a net asset value of the financial assets of the fund,
(c) at least once per minute, an indicator of the net asset value synthesized from at least one of components of the fund and one or more other correlated assets, and
(d) one or more other indicators of a value of the financial assets; and
a broker platform interposed between and coupled in a communicating relationship with the authorized participant platform and the investment company platform, the broker platform configured to:
respond to a creation request from the authorized participant platform by requesting and receiving in-kind a first amount of the substitute basket from the authorized participant platform equal in value to a creation unit of the shares in the exchange-traded fund, requesting the selection and weighting of the financial assets held by the fund from the investment company platform, executing one or more trades on the secondary market to convert the first amount of the substitute basket into a second amount of a fund basket equal in value to the creation unit and having the selection and weighting of financial assets held by the fund without disclosing a composition of the fund to the authorized participant platform, executing an in-kind exchange with the investment company platform of the fund basket for a first number of shares of the exchange-traded fund equal to the creation unit, and transmitting the first number of shares to the authorized participant platform for trading on the secondary market in exchange for the first amount of the substitute basket received in-kind from the authorized participant, and
respond to a redemption request from the authorized participant platform by receiving a second number of shares of the exchange-traded fund equal to the creation unit from the authorized participant platform, receiving in-kind a third amount of the fund basket equal in value to the creation unit and having the selection and weighting of financial assets held by the fund, executing one or more other trades on the secondary market to convert the third amount of the fund basket into a fourth amount of the substitute basket equal in value to the creation unit without disclosing the composition of the fund to the authorized participant platform, and exchanging in-kind the fourth amount of the substitute basket for the second number of shares of the exchange-traded fund received from the authorized participant platform.

7. The system of claim 6 wherein the substitute basket includes one or more financial assets not held by the fund.

8. The system of claim 6 wherein the substitute basket has an active share of 5% to 20% relative to a benchmark based on the selection and weighting of the financial assets held by the fund.

9. The system of claim 6 wherein the substitute basket has an active share of 5% to 30% relative to a benchmark based on the selection and weighting of the financial assets held by the fund.

10. A system comprising:
an investment company platform hosted by an investment company, the investment company actively and non-transparently managing a fund, the fund having a composition including a selection and weighting of financial assets determined according to a proprietary investment strategy of the investment company and a number of exchange-traded shares traded independently from the investment company on a secondary market, at least one of the financial assets held by the fund trading on a different market geographically and temporally offset from the secondary market;
a memory storing a record of the selection and weighting of financial assets held by the fund, and a record of a substitute basket substantially overlapping with the selection and weighting of the financial assets held by the fund, the substitute basket selected and weighted to correlate in value with the fund to within a predetermined threshold, to have an active share of 5% to 30% relative to a benchmark based on the selection and weighting of the financial assets held by the fund, and to have a forecasted daily tracking error within a predetermined tracking error threshold relative to the fund;
one or more data feeds from remote sources of data for the secondary market and the different market, the one or more data feeds including one or more feeds of public trading data for listed securities, at least one evaluative engine for estimating an intraday value of one of the financial assets trading on the different market when the secondary market is open and the different market is closed; and
one or more processors executing on the investment company platform, wherein the investment company platform is configured by computer code executing on the one or more processors to calculate and publish a number of portfolio metrics to facilitate transactions in the exchange-traded shares on the secondary market without access to the selection and weighting of financial assets held by the fund, the portfolio metrics including:
(a) a net asset value for the fund, the net asset value calculated and published by the investment company platform two or more times during each trading day for the secondary market, including at least once at the close of trading for the secondary market and at least once at the closing of trading for the different market,
(b) an indicative net asset value, the indicative net asset value calculated and published at least once each minute during each trading day, the indicative net asset value including at least one price from the evaluative engine for one of the financial assets traded on the different market and at least one other price for an asset correlated but not identical to one of the financial assets held by the fund,
(c) a deviation of the indicative net asset value from the net asset value at the end of each trading day,
(d) before the beginning of each trading day, the substitute basket and the forecasted daily tracking error for the substitute basket,
(e) before the beginning of each trading day, one or more correlated assets trading synchronously with the exchange-traded shares and having an individual or aggregate value correlated to the net asset value of the fund, and
(f) weightings of fund holdings by one or more of industry, sector, country, and currency.

11. The system of claim 10 wherein the predetermined tracking error threshold does not exceed five basis points of the value of the fund.

12. A method for creating a substitute basket representative of, but not identical to, a composition of financial assets held by an actively managed, non-transparent fund, the method comprising:
storing a composition of the fund, the composition including a selection and weight for a number of financial assets held by the fund;
storing a transaction cost metric for each of the number of financial assets;
storing a number of asset types, each asset type having a number of categories exhaustively characterizing the financial assets held by the fund;
receiving an inclusion score for each of the number of financial assets from a portfolio manager for the fund, wherein a positive value for one of the inclusion scores weights a corresponding one of the number of financial assets to favor inclusion in the substitute basket, a negative value for one of the inclusion scores weights the corresponding one of the number of financial assets to favor exclusion from the substitute basket, and a zero inclusion score reduces an effect of a current weighting of the corresponding one of the number of financial assets in the fund on inclusion in the substitute basket;
determining an adjusted weight for each financial asset in the substitute basket according to an objective function that maximizes a weighted average inclusion score and a liquidity for the substitute basket, while constraining the adjusted weights such that: (1) allocations in the substitute basket remain within a predetermined percentage for each of the number of categories for each asset type held by the fund, (2) the substitute basket has an active share of five to twenty percent relative to a benchmark based on the fund, (3) the adjusted weight is no less than one tenth of one percent for any non-zero adjusted weight, and (4) the substitute basket has a forecasted daily tracking error less that a predetermined threshold; and
publishing the substitute basket before a beginning of each trading day for a market that trades shares in the fund, the substitute basket for use by market participants in valuing shares of the fund without receiving the composition of the fund.

13. The method of claim 12 further comprising publishing an indicative net asset value for the fund at least once every fifteen seconds during the trading day, the indicative net asset value including an estimate of a value of the fund.

14. The method of claim 12 further comprising publishing a net asset value for the fund two or more times during the trading day for the market.

15. The method of claim 12 wherein the fund includes at least one asset traded on a secondary market that is closed for at least a portion of the trading day for the market.

16. The method of claim 12 wherein the fund includes at least one foreign equity traded on a foreign stock exchange.

17. The method of claim 12 further comprising monitoring the daily tracking error for the substitute basket during the trading day.

18. The method of claim 17 further comprising publicly reporting the tracking error.

19. The method of claim 17 further comprising providing a signal for fund intervention when the daily tracking error exceeds a limit greater than the predetermined threshold.

20. The method of claim 12 wherein the forecasted daily tracking error is one standard deviation of a historical tracking error for the substitute basket.

21. The method of claim 12 wherein the predetermined threshold for the daily tracking error is not greater than five basis points of a net asset value of the fund.

22. The method of claim 12 wherein at least one of the adjusted weights is zero.

23. The method of claim 12 wherein the liquidity of the substitute basket is inversely related to a transaction cost for trading in each of the financial assets in the substitute basket.

24. The method of claim 23 wherein the transaction cost metric includes a median dollar trading volume for each of the number of financial assets over a predetermined historical window.

25. The method of claim 23 wherein the transaction cost metric is based on one or more of a bid-ask spread, a volatility, an actual transaction cost, and a commission for trading in each of the number of financial assets.

26. The method of claim 12 further comprising facilitating a primary market transaction for shares in the fund wherein an authorized participant exchanges the substitute basket for a creation unit.

27. A computer program product for creating a substitute basket representative of, but not identical to, a composition of financial assets held by an actively managed, non-transparent fund, the computer program product comprising computer executable code embodied in a non-transitory computer readable medium that, when executing on one or more computing devices, performs the steps of:
storing a composition of the fund, the composition including a selection and weight for a number of financial assets held by the fund;
storing a transaction cost metric for each of the number of financial assets;
storing a number of asset types, each asset type having a number of categories exhaustively characterizing the financial assets held by the fund;
receiving an inclusion score for each of the number of financial assets from a portfolio manager for the fund, wherein a positive value for one of the inclusion scores weights a corresponding one of the number of financial assets to favor inclusion in the substitute basket, a negative value for one of the inclusion scores weights the corresponding one of the number of financial assets to favor exclusion from the substitute basket, and a zero inclusion score reduces an effect of a current weighting of the corresponding one of the number of financial assets in the fund on inclusion in the substitute basket;
determining an adjusted weight for each financial asset in the substitute basket according to an objective function that maximizes a weighted average inclusion score and a liquidity for the substitute basket, while constraining the adjusted weights such that: (1) allocations in the substitute basket remain within a predetermined percentage for each of the number of categories for each asset type held by the fund, (2) the substitute basket has an active share of five to twenty percent relative to a benchmark based on the fund, (3) the adjusted weight is no less than one tenth of one percent for any non-zero adjusted weight, and (4) the substitute basket has a forecasted daily tracking error less than a predetermined threshold; and
publishing the substitute basket before a beginning of each trading day for a market that trades shares in the fund, the substitute basket for use by market participants in valuing shares of the fund without receiving the composition of the fund.

28. A system comprising:
an investment company platform hosted by an investment company, the investment company actively and non-transparently managing a fund, the fund having a composition including a selection and weighting of financial assets determined according to a proprietary investment strategy of the investment company and the fund traded in two or more share types including a number of mutual fund shares traded by the investment company with market participants and a number of exchange-traded shares traded independently from the investment company on a secondary market;
a memory storing a record of the selection and weighting of financial assets held by the fund, and a record of a substitute basket substantially overlapping with the selection and weighting of the financial assets held by the fund, the substitute basket selected and weighted to correlate in value with the fund to within a predetermined threshold, to have an active share of 5% to 30% relative to a benchmark based on the selection and weighting of the financial assets held by the fund, and to have a forecasted daily tracking error within a predetermined tracking error threshold relative to the fund;
one or more data feeds from remote sources of data for the secondary market and a different market, the one or more data feeds including one or more feeds of public trading data for listed securities, at least one evaluative engine for estimating an intraday value of one of the financial assets trading on the different market when the secondary market is open and the different market is closed; and
one or more processors executing on the investment company platform, wherein the investment company platform is configured by computer code executing on the one or more processors to calculate and publish a number of portfolio metrics to facilitate transactions in the exchange-traded shares on the secondary market without access to the selection and weighting of financial assets held by the fund, the portfolio metrics including at least one of:
(a) a net asset value for the fund, the net asset value calculated and published by the investment company platform two or more times during each trading day for the secondary market, including at least once at the close of trading for the secondary market and at least once at the closing of trading for the different market,
(b) an indicative net asset value, the indicative net asset value calculated and published at least once each minute during each trading day, the indicative net asset value including at least one price from the evaluative engine for one of the financial assets traded on the different market and at least one other price for an asset correlated but not identical to one of the financial assets held by the fund,
(c) a deviation of the indicative net asset value from the net asset value at the end of each trading day,
(d) before the beginning of each trading day, the substitute basket and the forecasted daily tracking error for the substitute basket,
(e) before the beginning of each trading day, one or more correlated assets trading synchronously with the exchange-traded shares and having an individual or aggregate value correlated to the net asset value of the fund, and
(f) weightings of fund holdings by one or more of industry, sector, country, and currency.
